(19) United States
(12) Patent Application Publication
(10) Pub. No.: US 2025/0189650 A1
(43) Pub. Date: Jun. 12, 2025

(54) DEDICATED RECEIVER COMPONENTS FOR MONO-SENSING PROCEDURES

(71) Applicant: QUALCOMM Incorporated, San Diego, CA (US)

(72) Inventors: Igor GUTMAN, Hod HaSharon (IL); Tao LUO, San Diego, CA (US); Wooseok NAM, San Diego, CA (US)

(21) Appl. No.: 18/537,197

(22) Filed: Dec. 12, 2023

(51) Int. Cl. G01S 13/06; H04B 1/04

(52) U.S. Cl. CPC G01S 13/06; H04B 1/04

(57) ABSTRACT

Methods, systems, and devices for wireless communication are described. A wireless communication device may include a first set of radio frequency (RF) communication components for transmitting and receiving RF signals (e.g., “full” communication components), and a second set of RF communication components that are able to receive but unable to transmit RF signals (e.g., “Rx-only” communication components). The wireless communication device may transmit one or more sensing signals using a first “full” RF communication component, the one or more sensing signals associated with an RF sensing procedure for detecting one or more objects. The wireless communication device select an “Rx-only” RF communication component based on determining that the other “full” RF communication components are unavailable for the RF sensing procedure. The wireless communication device may then receive reflections of the one or more sensing signals via the Rx-only RF communication component as part of the RF sensing procedure.

### TECHNICAL FIELD

The following relates to wireless communication, including dedicated receiver components for mono-sensing procedures.

### DESCRIPTION OF THE RELATED TECHNOLOGY

Wireless communication systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

Wireless communication devices (for example, UEs) may be able to perform radio frequency (RF) sensing procedures, such as in examples in which the device transmits one or more RF sensing signals from a first RF module (transmitting (Tx) module) and receives the one or more RF sensing signals from a second RF module (receiving (Rx) module). However, due to space and cost constraints, wireless communication devices may have a limited quantity of RF modules. For example, UEs may include only two RF modules: one on the front of the UE, and one on the back of the UE. As such, when one of the RF modules is unusable (for example, when the UE is laying down on a table or other surface, thereby blocking one of the RF modules), the UE may be unable to adequately perform RF sensing procedures. Adding other RF modules to wireless communication devices may not be feasible in many circumstances due to spatial constraints on the wireless communication devices, a complexity of such other RF modules, cost considerations, and/or other challenges.

### SUMMARY

The systems, methods and devices of this disclosure each have several innovative aspects, no single one of which is solely responsible for the desirable attributes disclosed herein.

A method for wireless communication by a wireless communication device is described. The method may include transmitting one or more sensing signals, associated with a radio frequency (RF) sensing procedure, using a first RF communication component from a first set of one or more RF communication components that are each associated with transmitting and receiving RF signals, selecting, in association with one or more of the first set of one or more RF communication components being unavailable for the RF sensing procedure, a second RF communication component from a second set of one or more RF communication components that are each associated with receiving RF signals and not associated with transmitting RF signals, and receiving one or more reflections of the one or more sensing signals using the second RF communication component.

Another innovative aspect of the subject matter described in this disclosure may be implemented in a wireless communication device. The wireless communication device may include one or more memories storing processor executable code, and one or more processors coupled with the one or more memories. The one or more processors may individually or collectively operable to execute the code to cause the wireless communication device to transmit one or more sensing signals, associated with a radio frequency (RF) sensing procedure, using a first RF communication component from a first set of one or more RF communication components that are each associated with transmitting and receiving RF signals, select, in association with one or more of the first set of one or more RF communication components being unavailable for the RF sensing procedure, a second RF communication component from a second set of one or more RF communication components that are each associated with receiving RF signals and not associated with transmitting RF signals, and receive one or more reflections of the one or more sensing signals using the second RF communication component.

Another innovative aspect of the subject matter described in this disclosure may be implemented in a wireless communication device. The wireless communication device may include means for transmitting one or more sensing signals, associated with a radio frequency (RF) sensing procedure, using a first RF communication component from a first set of one or more RF communication components that are each associated with transmitting and receiving RF signals, means for selecting, in association with one or more of the first set of one or more RF communication components being unavailable for the RF sensing procedure, a second RF communication component from a second set of one or more RF communication components that are each associated with receiving RF signals and not associated with transmitting RF signals, and means for receiving one or more reflections of the one or more sensing signals using the second RF communication component.

Another innovative aspect of the subject matter described in this disclosure may be implemented in a non-transitory computer-readable medium storing code. The code may include instructions executable by a processor to transmit one or more sensing signals, associated with a radio frequency (RF) sensing procedure, using a first RF communication component from a first set of one or more RF communication components that are each associated with transmitting and receiving RF signals, select, in association with one or more of the first set of one or more RF communication components being unavailable for the RF sensing procedure, a second RF communication component from a second set of one or more RF communication components that are each associated with receiving RF signals and not associated with transmitting RF signals, and receive one or more reflections of the one or more sensing signals using the second RF communication component.

### BRIEF DESCRIPTION OF THE DRAWINGS

FIG. 1 shows an example of a wireless communication system that supports dedicated receiver components for mono-sensing procedures in accordance with one or more aspects of the present disclosure.

FIG. 2 shows an example of a wireless communication system that supports dedicated receiver components for mono-sensing procedures in accordance with one or more aspects of the present disclosure.

FIG. 3 shows an example of a Tx/Rx chain that supports dedicated receiver components for mono-sensing procedures in accordance with one or more aspects of the present disclosure.

FIG. 4 shows an example of a Tx/Rx chain that supports dedicated receiver components for mono-sensing procedures in accordance with one or more aspects of the present disclosure.

FIG. 5 shows an example of a process flow that supports dedicated receiver components for mono-sensing procedures in accordance with one or more aspects of the present disclosure.

FIGS. 6 and 7 show block diagrams of devices that support dedicated receiver components for mono-sensing procedures in accordance with one or more aspects of the present disclosure.

FIG. 8 shows a block diagram of a communication manager that supports dedicated receiver components for mono-sensing procedures in accordance with one or more aspects of the present disclosure.

FIG. 9 shows a diagram of a system including a device that supports dedicated receiver components for mono-sensing procedures in accordance with one or more aspects of the present disclosure.

FIGS. 10 through 12 show flowcharts illustrating methods that support dedicated receiver components for mono-sensing procedures in accordance with one or more aspects of the present disclosure.

### DETAILED DESCRIPTION

Wireless communication devices (for example, user equipments (UEs)) may be able to perform radio frequency (RF) sensing procedures, such as in examples in which the device transmits one or more RF sensing signals from a first RF module (transmitting (Tx) module, Tx communication component) and receives the one or more RF sensing signals from a second RF module (receiving (Rx) module, Rx communication component). Such sensing procedures may be used for gesture recognition (for example, user waving their hand over a UE to turn off an alarm), tracking objects, and/or other implementations. However, due to space and cost constraints, wireless communication devices may have a limited number of RF modules. For example, UEs may include only two RF modules: one on the front of the UE, and one on the back of the UE. As such, when one of the RF modules is unusable (for example, when the UE is laying down on a table or other surface, thereby blocking one of the RF modules), the UE may be unable to adequately perform RF sensing procedures. Adding other RF modules to wireless communication devices may not be feasible in many circumstances due to spatial constraints on the wireless communication devices, a complexity of such other RF modules, cost considerations, and/or other challenges.

Aspects of the present disclosure are directed to the use of “reception-only” (Rx-only) RF modules (for example, Rx-only RF communication components) that may be used to receive RF sensing signals to facilitate RF sensing procedures. Compared to “full” RF modules (for example, “full” RF communication components) that are able to transmit and receive signals, Rx-only RF modules may only be able to receive signals (for example, unable to transmit), and may therefore be smaller, cheaper, and less sophisticated compared to full RF modules. For example, a UE may transmit sensing signals using a (full) RF module (for example, Tx RF module), and may determine that one or more other full RF modules are unavailable for the RF sensing procedure (for example, due to antenna elements of other RF modules being obstructed). In such cases, the UE may select an Rx-only RF module that will be used to receive the sensing signals. The UE may select the Rx-only RF module based on a distance between the Tx RF module (to reduce self-interference), and/or a signal leakage metric between the Tx RF module and the Rx-only RF module, among other criteria. In some cases, the Rx-only RF modules may include antenna elements that are used only to receive signals, and may include limited (or no) processing capabilities. As such, upon receiving the sensing signals, the Rx-only RF module may route the received signals to a full RF module of the UE for processing. For the purposes of the present disclosure, the terms “RF module,” “RF communication component,” and like terms, may be used interchangeably to refer to sets of devices/components that may be used to transmit and/or receive wireless communications at a wireless communication device.

Particular aspects of the subject matter described in this disclosure may be implemented to realize one or more of the following potential advantages. The described communication devices may include smaller and more cost-efficient Rx-only RF communication components (Rx-only RF modules) that may be used for various communication operations and procedures, such as RF sensing procedures, because the Rx-only RF communication components are less complex and less expensive than full RF communication components. Implementing one (or more) Rx-only RF communication components in a device may enable the device to perform RF sensing operations even in cases in which “full” RF communication components are blocked or otherwise unavailable. Moreover, the addition of smaller and less complex Rx-only RF communication components may expand receiving capabilities of wireless devices compared to other wireless devices that include only larger and more complex “full” RF communication components. Further, the use of additional Rx-only RF communication components may eliminate self-interference that may otherwise be experienced at a device using a single communication component to both transmit and receive signals. Therefore, techniques described herein may reduce or eliminate the need for self-interference cancellation techniques, thereby reducing complexity of an RF front-end (RFFE) and increasing a range of radar/RF sensing procedures.

Aspects of the disclosure are initially described in the context of wireless communication systems. Additional aspects of the disclosure are directed to example Tx/Rx chains and an example process flow. Aspects of the disclosure are further illustrated by and described with reference to apparatus diagrams, system diagrams, and flowcharts that relate to dedicated receiver components for mono-sensing procedures.

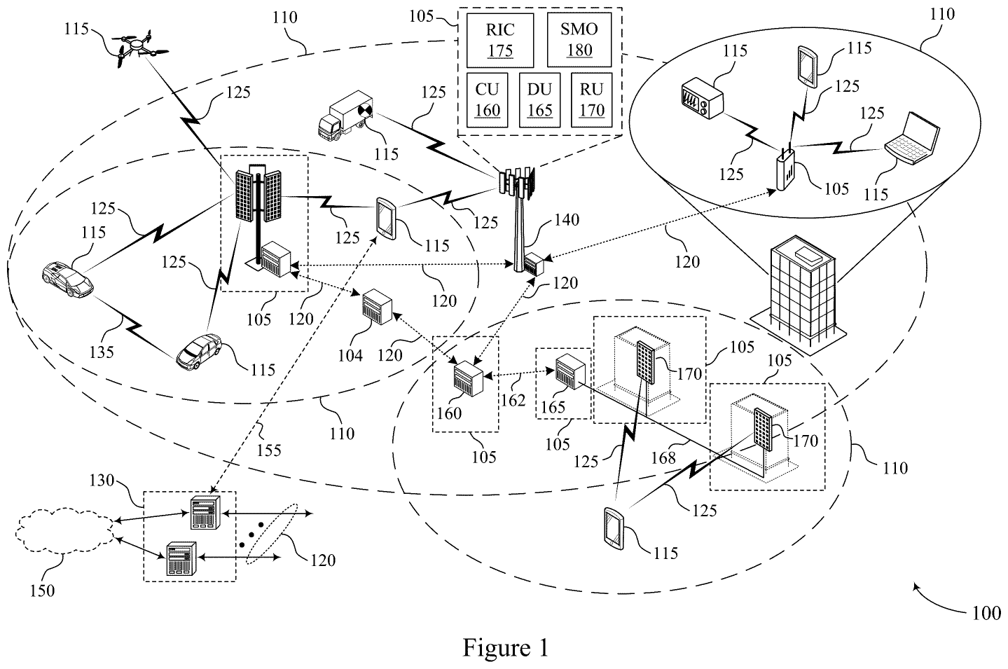

FIG. 1 shows an example of a wireless communication system 100 that supports dedicated receiver components for mono-sensing procedures in accordance with one or more aspects of the present disclosure. The wireless communication system 100 may include one or more network entities 105, one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (for example, an RF access link). For example, a network entity 105 may support a coverage area 110 (for example, a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communication with various types of devices, such as other UEs 115 or network entities 105, as shown in FIG. 1.

As described herein, a node of the wireless communication system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (for example, in accordance with an S1, N2, N3, or other interface protocol). In some examples, network entities 105 may communicate with one another via a backhaul communication link 120 (for example, in accordance with an X2, Xn, or other interface protocol) either directly (for example, directly between network entities 105) or indirectly (for example, via a core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication links 120, midhaul communication links 162, or fronthaul communication links 168 may be or include one or more wired links (for example, an electrical link, an optical fiber link), one or more wireless links (for example, a radio link, a wireless optical link), among other examples or various combinations thereof. A UE 115 may communicate with the core network 130 via a communication link 155.

One or more of the network entities 105 described herein may include or may be referred to as a base station 140 (for example, a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within a single network entity 105 (for example, a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU) 160, a distributed unit (DU) 165, a radio unit (RU) 170, a RAN Intelligent Controller (RIC) 175 (for example, a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 170 is flexible and may support different functionalities depending on which functions (for example, network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3 (L3), layer 2 (L2)) functionality and signaling (for example, Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or more RUs 170). In some cases, a functional split between a CU 160 and a DU 165, or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (for example, F1, F1-c, F1-u), and a DU 165 may be connected to one or more RUs 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities 105 that are in communication via such communication links.

In wireless communication systems (for example, wireless communication system 100), infrastructure and spectral resources for radio access may support wireless backhaul link capabilities to supplement wired backhaul connections, providing an IAB network architecture (for example, to a core network 130). In some cases, in an IAB network, one or more network entities 105 (for example, IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (for example, a donor base station 140). The one or more donor network entities 105 (for example, IAB donors) may be in communication with one or more additional network entities 105 (for example, IAB nodes 104) via supported access and backhaul links (for example, backhaul communication links 120). IAB nodes 104 may include an IAB mobile termination (IAB-MT) controlled (for example, scheduled) by DUs 165 of a coupled IAB donor. An IAB-MT may include an independent set of antennas for relay of communication with UEs 115, or may share the same antennas (for example, of an RU 170) of an IAB node 104 used for access via the DU 165 of the IAB node 104 (for example, referred to as virtual IAB-MT (vIAB-MT)). In some examples, the IAB nodes 104 may include DUs 165 that support communication links with additional entities (for example, IAB nodes 104, UEs 115) within the relay chain or configuration of the access network (for example, downstream). In such cases, one or more components of the disaggregated RAN architecture (for example, one or more IAB nodes 104 or components of IAB nodes 104) may be configured to operate according to the techniques described herein.

For instance, an access network (AN) or RAN may include communication between access nodes (for example, an IAB donor), IAB nodes 104, and one or more UEs 115. The IAB donor may facilitate connection between the core network 130 and the AN (for example, via a wired or wireless connection to the core network 130). That is, an IAB donor may refer to a RAN node with a wired or wireless connection to core network 130. The IAB donor may include a CU 160 and at least one DU 165 (for example, and RU 170), in which case the CU 160 may communicate with the core network 130 via an interface (for example, a backhaul link). IAB donor and IAB nodes 104 may communicate via an F1 interface according to a protocol that defines signaling messages (for example, an F1 AP protocol). Additionally, or alternatively, the CU 160 may communicate with the core network via an interface, which may be an example of a portion of backhaul link, and may communicate with other CUs 160 (for example, a CU 160 associated with an alternative IAB donor) via an Xn-C interface, which may be an example of a portion of a backhaul link.

An IAB node 104 may refer to a RAN node that provides IAB functionality (for example, access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (for example, an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (for example, DUs 165) may provide a Uu interface for a parent IAB node 104 to signal to a child IAB node 104 or UE 115.

For example, IAB node 104 may be referred to as a parent node that supports communication for a child IAB node, or referred to as a child IAB node associated with an IAB donor, or both. The IAB donor may include a CU 160 with a wired or wireless connection (for example, a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (for example, transmissions to the UEs 115 relayed from the IAB donor) through the DUs 165. That is, data may be relayed to and from IAB nodes 104 via signaling via an NR Uu interface to MT of the IAB node 104. Communication with IAB node 104 may be scheduled by a DU 165 of IAB donor and communication with IAB node 104 may be scheduled by DU 165 of IAB node 104.

In the case of the techniques described herein applied in the context of a disaggregated RAN architecture, one or more components of the disaggregated RAN architecture may be configured to support dedicated receiver components for mono-sensing procedures as described herein. For example, some operations described as being performed by a UE 115 or a network entity 105 (for example, a base station 140) may additionally, or alternatively, be performed by one or more components of the disaggregated RAN architecture (for example, IAB nodes 104, DUs 165, CUs 160, RUs 170, RIC 175, SMO 180).

A UE 115 may include or may be referred to as a mobile device, a wireless communication device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communication (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (for example, an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities 105).

In some examples, such as in a carrier aggregation configuration, a carrier may also have acquisition signaling or control signaling that coordinates operations for other carriers. A carrier may be associated with a frequency channel (for example, an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (for example, of the same or a different radio access technology).

The communication links 125 shown in the wireless communication system 100 may include downlink transmissions (for example, forward link transmissions) from a network entity 105 to a UE 115, uplink transmissions (for example, return link transmissions) from a UE 115 to a network entity 105, or both, among other configurations of transmissions. Carriers may carry downlink or uplink communication (for example, in an FDD mode) or may be configured to carry downlink and uplink communication (for example, in a TDD mode).

A carrier may be associated with a particular bandwidth of the RF spectrum and, in some examples, the carrier bandwidth may be referred to as a “system bandwidth” of the carrier or the wireless communication system 100. For example, the carrier bandwidth may be one of a set of bandwidths for carriers of a particular radio access technology (for example, 1.4, 3, 5, 10, 15, 20, 40, or 80 megahertz (MHz)). Devices of the wireless communication system 100 (for example, the network entities 105, the UEs 115, or both) may have hardware configurations that support communication using a particular carrier bandwidth or may be configurable to support communication using one of a set of carrier bandwidths. In some examples, the wireless communication system 100 may include network entities 105 or UEs 115 that support concurrent communication using carriers associated with multiple carrier bandwidths. In some examples, each served UE 115 may be configured for operating using portions (for example, a sub-band, a BWP) or all of a carrier bandwidth.

Signal waveforms transmitted via a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both), such that a relatively higher quantity of resource elements (for example, in a transmission duration) and a relatively higher order of a modulation scheme may correspond to a relatively higher rate of communication. A wireless communication resource may refer to a combination of an RF spectrum resource, a time resource, and a spatial resource (for example, a spatial layer, a beam), and the use of multiple spatial resources may increase the data rate or data integrity for communication with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communication for the UE 115 may be restricted to one or more active BWPs.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communication resource may be organized according to radio frames each having a specified duration (for example, 10 milliseconds (ms)). Each radio frame may be identified by a system frame number (SFN) (for example, ranging from 0 to 1023).

Each frame may include multiple consecutively-numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communication systems 100, a slot may further be divided into multiple mini-slots associated with one or more symbols. Excluding the cyclic prefix, each symbol period may be associated with one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communication system 100 and may be referred to as a transmission time interval (TTI). In some examples, the TTI duration (for example, a quantity of symbol periods in a TTI) may be variable. Additionally, or alternatively, the smallest scheduling unit of the wireless communication system 100 may be dynamically selected (for example, in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (for example, a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communication (for example, a mode that supports one-way communication via transmission or reception, but not transmission and reception concurrently). In some examples, half-duplex communication may be performed at a reduced peak rate. Other power conservation techniques for the UEs 115 include entering a power saving deep sleep mode when not engaging in active communication, operating using a limited bandwidth (for example, according to narrowband communication), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communication system 100 may be configured to support ultra-reliable communication or low-latency communication, or various combinations thereof. For example, the wireless communication system 100 may be configured to support ultra-reliable low-latency communication (URLLC). The UEs 115 may be designed to support ultra-reliable, low-latency, or critical functions. Ultra-reliable communication may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (for example, in accordance with a peer-to-peer (P2P), D2D, or sidelink protocol). In some examples, one or more UEs 115 of a group that are performing D2D communication may be within the coverage area 110 of a network entity 105 (for example, a base station 140, an RU 170), which may support aspects of such D2D communication being configured by (for example, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communication may support a one-to-many (1:M) system in which each UE 115 transmits to each of the other UEs 115 in the group. In some examples, a network entity 105 may facilitate the scheduling of resources for D2D communication. In some other examples, D2D communication may be carried out between the UEs 115 without an involvement of a network entity 105.

In some systems, a D2D communication link 135 may be an example of a communication channel, such as a sidelink communication channel, between vehicles (for example, UEs 115). In some examples, vehicles may communicate using vehicle-to-everything (V2X) communication, vehicle-to-vehicle (V2V) communication, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, network entities 105, base stations 140, RUs 170) using vehicle-to-network (V2N) communication, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (for example, less than 100 kilometers) compared to communication using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (for example, LAA). Operations using unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communication, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communication with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communication to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (for example, the same codeword) or different data streams (for example, different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit (Tx) beam, a receive (Rx) beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A network entity 105 or a UE 115 may use beam sweeping techniques as part of beamforming operations. For example, a network entity 105 (for example, a base station 140, an RU 170) may use multiple antennas or antenna arrays (for example, antenna panels) to conduct beamforming operations for directional communication with a UE 115. Some signals (for example, synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (for example, by a transmitting device, such as a network entity 105, or by a receiving device, such as a UE 115) a beam direction for later transmission or reception by the network entity 105.

Some signals, such as data signals associated with a particular receiving device, may be transmitted by transmitting device (for example, a transmitting network entity 105, a transmitting UE 115) along a single beam direction (for example, a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (for example, by a network entity 105 or a UE 115) may be performed using multiple beam directions, and the device may use a combination of digital precoding or beamforming to generate a combined beam for transmission (for example, from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted along one or more directions by a network entity 105 (for example, a base station 140, an RU 170), a UE 115 may employ similar techniques for transmitting signals multiple times along different directions (for example, for identifying a beam direction for subsequent transmission or reception by the UE 115) or for transmitting a signal along a single direction (for example, for transmitting data to a receiving device).

A receiving device (for example, a UE 115) may perform reception operations in accordance with multiple receive configurations (for example, directional listening) when receiving various signals from a transmitting device (for example, a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, when receiving a data signal). The single receive configuration may be aligned along a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communication at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (for example, a communication link 125, a D2D communication link 135). HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communication devices (for example, UEs 115, IAB nodes, customer premises equipment (CPE), etc.) of the wireless communication system 100 may be configured to support Rx-only RF modules (for example, Rx-only RF communication components) that may be used to receive RF sensing signals to facilitate RF sensing procedures. As compared to “conventional” or “full” RF modules that are able to transmit and receive signals, Rx-only RF modules may only be able to receive signals (for example, unable to transmit), and may therefore be smaller, cheaper, and less sophisticated as compared to full RF modules.

For example, a UE 115 of the wireless communication system 100 may transmit sensing signals using a (full) RF module (for example, Tx RF module), and may determine that other full RF modules are unavailable for the RF sensing procedure (for example, due to antenna elements of other RF modules being obstructed). In such cases, the UE 115 may select an Rx-only RF module that will be used to receive the sensing signals. The UE may select the Rx-only RF module based on a distance between the Tx RF module (to reduce self-interference), and a signal leakage metric between the Tx RF module and the Rx-only RF module. In some cases, the Rx-only RF modules may only include antenna elements that are used to receive signals, and may include limited (or no) processing capabilities. As such, upon receiving the sensing signals, the Rx-only RF module may route the received signals to the other full RF modules of the UE for processing.

Aspects of the present disclosure are directed to smaller and more cost-efficient Rx-only RF communication components (Rx-only RF modules) that may be used for various communication operations and procedures, such as RF sensing procedures. Implementing one (or more) Rx-only RF communication components in a device may provide additional components/modules that may be used for RF sensing procedures, thereby enabling wireless communication devices to perform RF sensing procedures even in cases in which “full” RF communication components are blocked or otherwise unavailable.

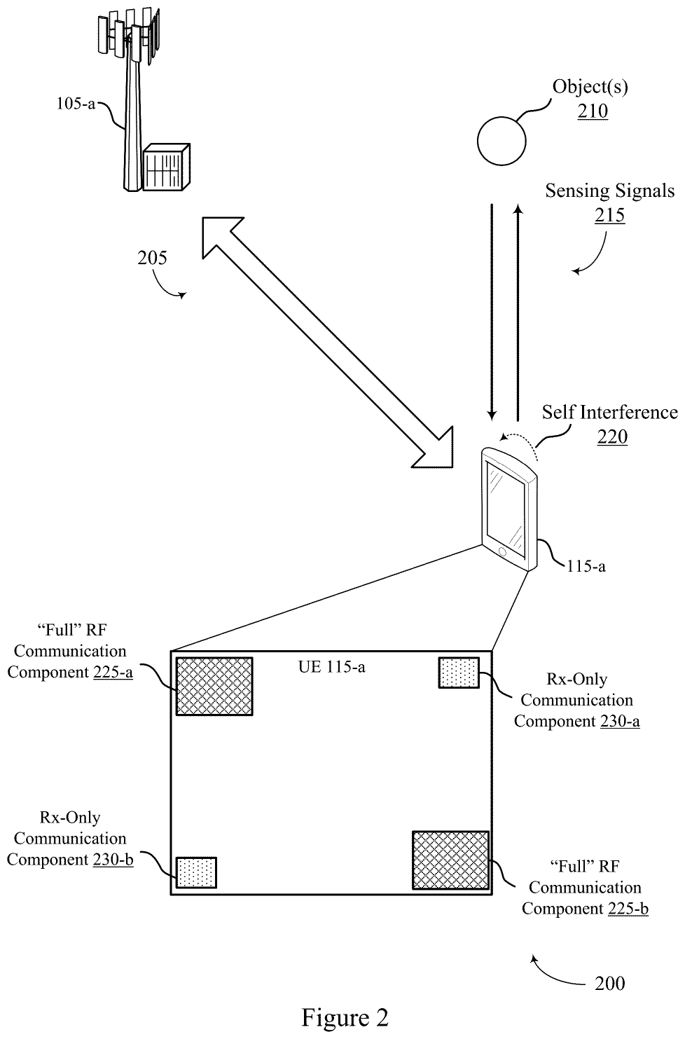

FIG. 2 shows an example of a wireless communication system 200 that supports dedicated receiver components for mono-sensing procedures in accordance with one or more aspects of the present disclosure. Aspects of the wireless communication system 200 may implement, or be implemented by, aspects of wireless communication system 100. The wireless communication system 200 may include a UE 115-a and a network entity 105-a, which may be examples of UEs 115 and network entities 105, and other wireless communication devices (for example, IAB nodes, CPE) as described with reference to FIG. 1.

The UE 115-a may communicate with the network entity 105-a using a communication link 205, which may be an example of an NR or LTE link between the UE 115-a and the network entity 105-a. In some cases, the communication link 205 may include an example of an access link (for example, Uu link). The communication link may include a bi-directional link that enables both uplink and downlink communication. For example, the UE 115-a may transmit uplink signals, such as uplink control signals or uplink data signals, to the network entity 105-a using the communication link 205, and the network entity 105-a may transmit downlink signals, such as downlink control signals or downlink data signals, to the UE 115-a using the communication link 205.

In some aspects, the UE 115-a may be configured to perform RF sensing procedures. As it is used herein, the term “RF sensing procedure” may be used to refer to procedures in which one or more wireless communication devices transmit sensing signals 215 which are reflected or refracted off objects 210 in order to identify the presence of the objects 210, determine a direction/velocity of the objects 210, track the objects 210, and the like. For example, RF sensing procedures may be used to identify “gestures” (for example, a user waving their hand to silence an alarm clock), track objects (for example, track the trajectory, spin, velocity of golf balls or other sports applications), and the like.

In some implementations, an RF sensing procedure may be performed between two or more wireless communication devices (for example, transmitting device, receiving device), in which case the RF sensing procedure may be referred to as a “cooperative RF sensing procedure” or “cooperative sensing.” During an RF sensing procedure, a transmitting device (for example, UE 115-a) transmits RF sensing signals 215 (for example, mmW signals), which may be reflected off objects 210 and received by a receiving device (for example, the transmitting wireless communication device, or one or more other wireless communication devices, such as the network entity 105-a). The receiving device may determine time delays, phase shifts, and other parameters associated with the received sensing signals 215 to identify one or more characteristics of the objects (for example, position, location, distance, etc.). The sensing range of the sensing signals 215 (for example, range within which object 210 may be identified via the RF sensing operation) may be a function of several parameters, including a transmit power of the sensing signals, antenna gain, bandwidth, wavelength, a length of cyclic prefixes, and the like.

In monostatic RF sensing procedures, a single wireless communication device (for example, the UE 115-a) may be configured to both transmit the sensing signals 215, and receive the sensing signals 215 reflected/refracted off objects 210 (for example, single device acts as co-located Tx/Rx device). Comparatively, in bistatic RF sensing procedures (cooperative sensing), sensing signals 215 may be transmitted and received by two different wireless communication devices (for example, non co-located Tx and Rx devices). Moreover, in multi-static RF sensing procedures (cooperative sensing), a single wireless communication device (for example, single Tx device) may transmit sensing signals 215 which are received by multiple receiving devices (for example, multiple Rx devices).

In order to perform wireless communication and RF sensing procedures, wireless communication devices may include multiple RF modules (for example, multiple RF communication components). For example, as shown in FIG. 2, the UE 115-a may include a first RF communication component 225-a and a second RF communication component 225-b. In some cases, the first RF communication component 225-a and the second RF communication component 225-b may be referred to as “full” communication components (for example, “full” RF modules) in that the RF communication components 225-a, 225-b are able to both transmit and receive communications. In some cases, the first RF communication component 225-a may be positioned on a first side (for example, front surface) of the UE 115-a, and the second RF communication component 225-b may be positioned on a second side (for example, back surface) of the UE 115-a. For the purposes of the present disclosure, the terms “RF module,” “RF communication component,” and like terms, may be used interchangeably to refer to sets of devices/components that may be used to transmit and/or receive wireless communications at a wireless communication device.

In the context of mono-sensing RF sensing procedures, the UE 115-a may not be able to utilize separate RF communication components 225-a, 225-b for transmitting and receiving sensing signals 215 (for example, separate Tx and Rx modules). In particular, the availability of RF communication components 225 may be based on a number of factors, including the number/quantity of total RF communication components 225 (RF modules) on the device, the co-existence of RF sensing procedures with other wireless traffic (for example, cellular traffic on 28 GHz and RF sensing on 60 GHz, or both on 28 GHz), external structures that block or otherwise interfere with communication at an RF communication component 225, and the like.

For example, as noted previously herein, RF sensing procedures may be used so that a user can wave their hand above the UE 115-a to silence an alarm. However, in cases in which the UE 115-a is laying down on a table, the first RF communication component 225-a may be facing up, but the second RF communication component 225-b may be blocked by the table, and may therefore be unusable. By way of another example, RF sensing procedures may be used to track golf ball trajectory and/or track a user's posture throughout a golf swing. In such cases, RF sensing procedures may only be performed using RF communication components 225 that are collocated with a camera of the UE 115-a (for example, on the same side as the camera).

These restrictions may result in cases in which one or more RF communication components 225 (for example, RF modules) are unavailable for communication and/or RF sensing procedures. Indeed, in some cases (such as in examples in which the UE 115-a includes only two separate RF communication components 225), there may only be a single RF module available for RF sensing procedures. As such, the UE 115-a may have to use the same RF communication component 225 for Rx and Rx (for example, H/V) We may have to use the same RF module for transmitting and receiving sensing signals 215. Using the same RF communication component 225 results in poor spatial separation between transmitted and received sensing signals 215, thereby resulting in poor/low isolation (for example, 30 dB). Such low isolation may impact the performance of the RF sensing procedure, such as leading to higher noise figure (NF) due to higher low noise amplifier (LNA) gain state (GS), and increased nonlinear effects of both Tx and Rx sensing signals 215.

For instance, in cases in which the UE 115-a only has a single RF communication component 225 available for an RF sensing procedure, the same RF communication component 225 may be used to transmit sensing signals 215 and receive the sensing signals 215. In such cases, the poor spatial separation may lead to self-interference 220, in examples in which signals transmitted by the UE 115-a interfere with received signals.

Several RF front end (RFFE) related noise-cancellation techniques have been explored to limit self-interference 220. However, such RFFE techniques have been found to limit the effective range of RF sensing procedures when the self-interference 220 leakage is large (such as when a single RF module is used to transmit and receive sensing signals 215). Noises that may limit the performance of RF sensing procedures may include, but are not limited to: Tx Nonlinearity (NL) noise due to the power amplifiers, the Rx thermal noise floor kTBFG (where k is the Boltzmann constant, T is the temperature in Kelvins, and B is the signal channel bandwidth), the Rx NL noise due to the analog front end (AFE) of the UE 115-a, and the Rx analog-to-digital conversion (ADC) noise.

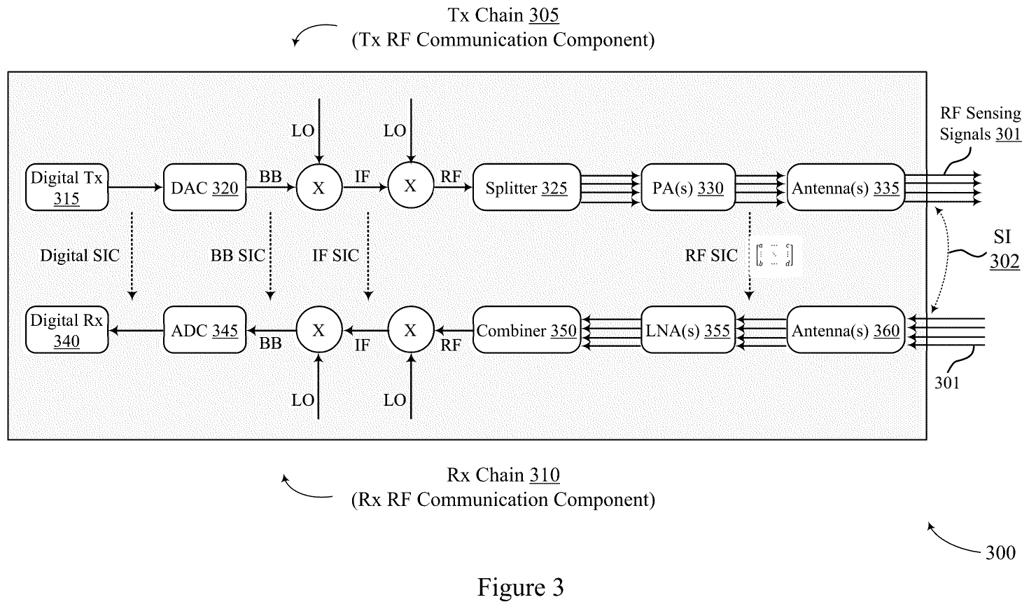

Some techniques for minimizing, cancelling, or otherwise addressing self-interference 220 may be further shown and described with reference to FIG. 3.

FIG. 3 shows an example of a Tx/Rx chain 300 that supports dedicated receiver components for mono-sensing procedures in accordance with one or more aspects of the present disclosure. Aspects of the Tx/Rx chain 300 may implement, or be implemented by, aspects of the wireless communication system 100, the wireless communication system 200, or both.

For example, the Tx/Rx chain 300 illustrated in FIG. 3 may include an example Tx/Rx chain of the UE 115-a shown and described in FIG. 2. For instance, the Tx/Rx chain 300 may include a Tx chain 305 (for example, Tx RF communication component) and an Rx chain 310 (for example, Rx RF communication component). In some cases, the Tx chain 305 and the Rx chain 310 illustrated in FIG. 3 may illustrate the respective components of a single RF communication component 225 illustrated in FIG. 2.

As shown in FIG. 3, the Tx chain 305 may include a digital Tx component 315, a digital-to-analog converter (DAC) component 320, a splitter 325, one or more power amplifiers (PAs) 330, and one or more antennas 335. The respective components of the Tx chain 305 may be used to transmit signals (for example, RF sensing signals 301) via the one or more antennas 335. Conversely, the Rx chain 310 may include one or more antennas 350, one or more LNAs 355, a combiner 350, an ADC component 345, and a digital Rx component 340. The respective components of the Rx chain 310 may be used to receive signals (for example, RF sensing signals 301) via the one or more antennas 360, where signals transmitted/received by the respective antennas 335, 360 may result in self-interference 302.

As noted previously herein, various techniques for minimizing or canceling self-interference 220 have been explored. Each respective technique is associated with its own shortfalls, which may include sensitivity loss (for example, range limitation, area cost) of an RF sensing procedure. There are two main families of self-interference cancellation techniques: (1) digital self-interference cancelation (D-SIC), and (2) analog self-interference cancelation (A-SIC). Both D-SIC and A-SIC come with their own advantages and disadvantages, and both categories result in decreased range for RF sensing procedures. Various self-interference cancellation techniques are summarized in Table 1 below:

TABLE 1
Self-Interference Cancellation Techniques

| Type | Algorithm | Description | Pros | Cons |
|---|---|---|---|---|
| D-SIC | NLIC | Modeling and | No sensitivity | Requires complex |
| | | canceling the | impact if | modeling of the |
| | | SI | modeled | PA and Rx AFE |
| | | | correctly | nonlinearity + |
| | | | | some desense loss |
| | Single tap | Canceling the | Simple | Sensitive to the |
| | MMSE | linear portion | implementation | PA and Rx |
| | cancelation | of SI | | AFE NL impact + |
| | | | | desense loss |
| | AS-IS | SI recording | Simple | 3dB thermal noise |
| | cancelation | and | implementation; | enhancement, |
| | | cancelation | small impact | could be |
| | | | from Rx AFE | mitigated by |
| | | | NL and of the | “repeated |
| | | | PA | recording”; |
| | | | | requires “clean” |
| | | | | measurement |
| | | | | of SI; some |
| | | | | desense loss |
| A-SIC | RF | Coupling | Captures the | High cost; high |
| | “Matrix” | each Tx | PA | desense loss, FFS |
| | | element with | nonlinearity; | exact number; |
| | | each Rx | avoids AFE | requires high |
| | | elements | nonlinearity; | quality phase |
| | | (Matrix) | avoids ADC | shifters/ |
| | RF | Coupling | saturation; | amplifiers, which |
| | “Vector” | single Tx | small NF | may be |
| | | element and | impact due to | challenging in |
| | | splitting | AFE GS | FR2 |
| | | among all Rx | | |
| | | elements | | |
| | | (Vector) | | |
| | IF | Coupling the | Avoids some | Does not capture |
| | | IF from TX | AFE | PA nonlinearity; |
| | | to RX | nonlinearity; | does not capture |
| | | | avoids ADC | some Rx AFE |
| | | | saturation | nonlinearity |
| | BB | Coupling the | Avoids ADC | Does not capture |
| | | BB from Tx | saturation | PA nonlinearity; |
| | | to Rx | (small impact | does not capture |
| | | | in sensing | AFE nonlinearity; |
| | | | applications) | Maximum NF |

The various self-interference cancellation (SIC) techniques summarized in Table 1 above may be performed at various locations along the Tx/Rx chain 300. For example, D-SIC techniques may be performed to address/cancel self-interference between the digital Tx/Rx components (for example, digital Tx component 315, digital Rx component 340) and the DAC/ADC (for example, DAC component 320, ADC component 345). Comparatively, broadband (BB) SIC and IF SIC may be performed along the portions of the Tx/Rx chain 300 for BB and IF, respectively. Moreover, RF SIC techniques (for example, RF “matrix” and RF “vector” SIC techniques may be performed between the antennas 335, 360 and the PAs 330/LNAs 355.

To summarize, and referring to the wireless communication system 200 illustrated in FIG. 2, there are several different techniques that may be implemented for SIC in order to reduce self-interference 220 experienced in wireless communication, including mono-sensing RF sensing procedures. Such self-interference 220 may typically arise in the context of mono-sensing procedures when the same RF communication component 225 is used for both transmitting and receiving sensing signals 215. For example, as described previously herein, when the second RF communication component 225-b is blocked or otherwise unusable (for example, being used for other communication or sensing procedures), the UE 115 may be forced to perform RF sensing procedures using the first RF communication component 225-a for both transmitting and receiving sensing signals 215, which may lead to increased self-interference 220.

Accordingly, aspects of the present disclosure are directed to the use of Rx-only RF modules (for example, Rx-only RF communication components 230-a, 230-b) that may be used to receive RF sensing signals to facilitate RF sensing procedures. That is, aspects of the present disclosure are directed to wireless communication devices that include one (or more) low-cost receiver(s) (for example, Rx-only RF communication components 230) that may be placed strategically/sparsely across the respective wireless communication device (for example, UE 115-a). In some cases, Rx-only RF communication components 230 (for example, Rx-only RF communication modules) may only be triggered or activated when the device determines that there is only a single RF module (for example, single RF communication components 225-a) that is exposed to the target (object 210). In other words, the UE 115-a may be configured to trigger or activate an Rx-only RF communication component 230-a for an RF sensing procedure when the UE 115-a determines that there is only a single RF communication component 225-a that is available/usable for the RF sensing procedure (where the remaining RF communication components 225 are blocked or otherwise unavailable).

As compared to “conventional” or “full” RF modules (for example, RF communication components 225) that are able to transmit and receive signals, Rx-only RF modules (for example, Rx-only RF communication components 230) may only be able to receive signals (for example, unable to transmit), and may therefore be smaller, cheaper, and less sophisticated as compared to full RF modules. For example, the UE 115-a may transmit sensing signals 215 using the first RF communication component 225-a, and may determine that the second RF communication component 225-b is unavailable for the RF sensing procedure (for example, due to antenna elements being obstructed, or based on the second RF communication components 225-b being used for other wireless communication/RF sensing procedures).

In such cases, the UE 115-a may select an Rx-only RF communication component 230 that will be used to receive the sensing signals 215. The UE 115-a may select which Rx-only RF communication component 230 will be used for the RF sensing procedure based on a distance between the Tx RF communication component 225-a and the respective Rx-only RF communication component 230-a, 230-b (to reduce self-interference), and a signal leakage metric between the Tx RF communication component 225-a and the respective Rx-only RF communication component 230.

In some cases, in order to select which Rx-only RF communication component 230 will be used, the UE 115-a may reference some data object (for example, table) that includes RF sensing parameters between the first RF communication component 225-a and the respective Rx-only RF communication components 230. For example, during some previous “calibration” session or “RF training procedure,” the UE 115-a may transmit and receive RF signals (for example, RF sensing signals 215) using various combinations of RF communication components 225, Tx beams, and Rx-only RF communication components 230. In such cases, the UE 115-a may observe signal strength/quality metrics, signal leakage metrics, and the like, across the various combinations of RF modules. As such, the UE 115-a may generate a table or other data object that includes RF sensing parameters for various combinations of RF communication components 225 and Rx-only RF communication components 230, including distances between the respective components, signal leakage metrics, signal strength/quality metrics (for example, on a per-Tx beam basis), and the like. As such, the UE 115-a may determine which full RF communication component 225 is being used for the RF sensing procedure (and/or which Tx beam is used), and may use this information to reference a previously-created data object to determine which Rx-only RF communication component 230 should be used.

Moreover, in some cases, the UE 115-a may be configured to use different Rx-only RF communication components 230 during different times/duration throughout the RF sensing procedure. In particular, as the object 210 moves relative to the UE 115-a (and/or as the UE 115-a moves relative to the object 210), the UE 115-a may be configured to use different Tx beams at the first RF communication component 225-a (and/or use different RF communication components 225 altogether) to transmit the RF sensing signals 215. In such cases, the relative quality of signals received at the respective Rx-only RF communication components 230 may change throughout the RF sensing procedure. As such, the UE 115-a may be configured to periodically (and/or aperiodically) evaluate which Rx-only RF communication component 230 should be used/activated for the RF sensing procedure. The UE 115-a may “know” (for example, in advance) which Rx-only RF communication component 230 should be used based on which Tx beams and/or which RF communication component 225 is used to transmit the sensing signals (for example, by referencing a table or other data object that includes RF sensing parameters). Additionally, or alternatively, the UE 115-a may select an Rx-only RF communication component 230, and may subsequently evaluate at regular or irregular intervals whether to switch to a different Rx-only RF communication component 230. For instance, the UE 115-a may activate/trigger a new Rx-only RF communication component 230-b that will be used for the RF sensing procedure if a signal strength of the sensing signals 215 received at the currently-activated Rx-only RF communication component 230-a drops below a threshold strength/quality.

In some cases, the Rx-only RF communication components 230 may only include antenna elements that are used to receive signals, and may include limited (or no) processing capabilities. As such, upon receiving the sensing signals, the Rx-only RF module may route the received signals to the other full RF modules (for example, full RF communication components 225) of the UE 115-a for processing. That is, the extra Rx-only receiver(s) may not include their own AFE (for example, LNA, VGA, filters, etc.), but may rather route signals to shoes of the main RF modules for processing.

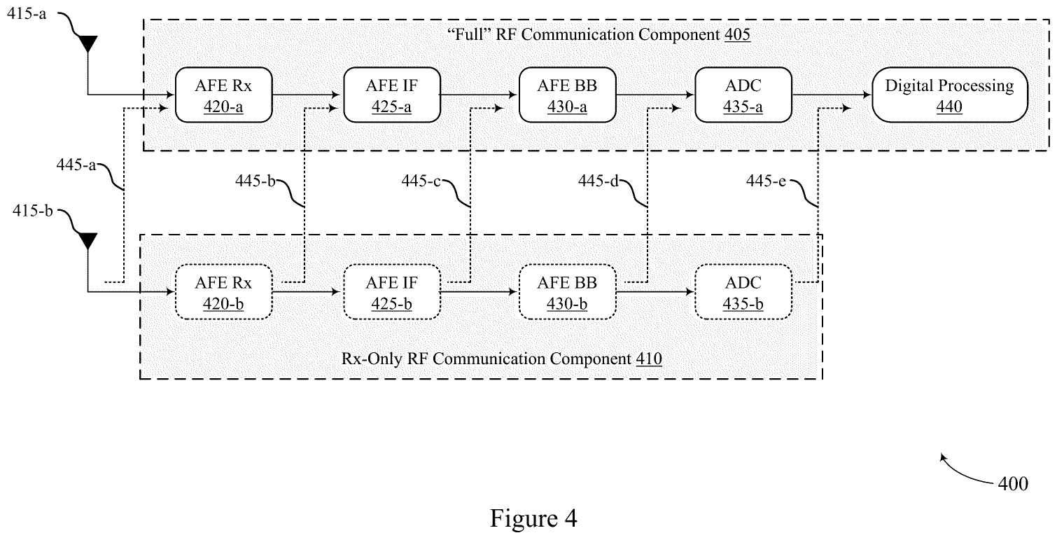

Different options for implementing Rx-only RF communication components 230 within a wireless communication device are further shown and described with reference to FIG. 4.

FIG. 4 shows an example of a Tx/Rx chain 400 that supports dedicated receiver components for mono-sensing procedures in accordance with one or more aspects of the present disclosure. Aspects of the Tx/Rx chain 400 may implement, or be implemented by, the wireless communication system 100, the wireless communication system 200, or both.

For example, the Tx/Rx chain 400 illustrated in FIG. 4 may include an example of a Tx/Rx chain of the UE 115-a illustrated in FIG. 2. For instance, the Tx/Rx chain 400 may include a “full” RF communication component 405 and an “Rx-only” RF communication component 410, which may be examples of a full RF communication component 225 and an Rx-only RF communication component 230, respectively, as illustrated in FIG. 2.

As described with reference to FIG. 3, the Tx/Rx chain 400 may include various components for transmitting and receiving wireless signals, such as sensing signals 415. For example, the RF communication component 405 may include one or more antenna elements 415-a, an AFE Rx component 420-a, an AFE IF component 425-a, an AFE BB component 430-a, an ADC component 435-a, and one or more digital processing components 430. Comparatively, the Rx-only RF communication component 410 may include one or more antenna elements 415-b, an AFE Rx component 420-b, an AFE IF component 425-b, an AFE BB component 430-b, and an ADC component 435-b.

In the context of an RF sensing procedure, a full RF communication component 405 may be configured to transmit sensing signals 215, and the Rx-only RF communication component 410 may be configured to receive the sensing signals 215 (for example, via the antenna elements 415-b). Additionally, or alternatively, the UE 115-a may transmit As noted previously herein, the Rx-only RF communication component 410 may be smaller and less complex (and therefore less expensive) as compared to the “full” RF communication component 405. In particular, the Rx-only RF communication component 410 may include limited (or no) components for processing received signals, and may instead be configured to route received signals to an available “full” RF communication component 405 for processing.

That is, the UE 115-a may transmit sensing signals 215 using a different “full” RF communication component 405 (not shown). In this example, the UE 115-a may receive the sensing signals 215 via the Rx-only RF communication component 410, where the Rx-only RF communication component 410 is configured to route the received sensing signals 215 to the RF communication component 405 for processing. There are several different implementations 445 or options that may be used for routing signals from the Rx-only RF communication component 410 to the full RF communication component 405. In some cases, the UE 115-a may have several different options/implementation 445 for routing signals from the Rx-only RF communication component 410 to the full RF communication component 405 based on different parameters or considerations, such as NF, leakage, etc.

In accordance with a first implementation 445-a, signals received by the Rx-only RF communication component 410 may be routed from the one or more antenna elements 415-b to the AFE Rx component 420-a of the full RF communication component 405. That is, the antenna output of the antenna elements 415-a may be coupled to the main Rx component (for example, AFE Rx component 420-a) of the full RF communication component 405. In such cases, the Rx-only RF communication component 410 may not perform any signal processing procedures/operations on the received signals, and may instead route the received signals to the full RF communication component 405 for processing.

In accordance with a second implementation 445-b, signals received by the Rx-only RF communication component 410 may be routed from an output of the AFE Rx component 420-b of the Rx-only RF communication component 410 to the AFE IF component 425-a of the full RF communication component 405. In such cases, the Rx-only RF communication component 410 may perform one or more signal processing procedures using the AFE Rx component 420-b, where the remaining signal processing procedures are performed using various components of the full RF communication component 405.

In accordance with a third implementation 445-c, signals received by the Rx-only RF communication component 410 may be routed from an output of the AFE IF component 425-b of the Rx-only RF communication component 410 to the AFE BB component 430-a of the full RF communication component 405. In such cases, the Rx-only RF communication component 410 may perform one or more signal processing procedures using the AFE Rx component 420-b and/or the AFE IF component 425-b, where the remaining signal processing procedures are performed using various components of the full RF communication component 405.

In accordance with a fourth implementation 445-d, signals received by the Rx-only RF communication component 410 may be routed from an output of the AFE BB component 430-b of the Rx-only RF communication component 410 to the ADC component 435-a of the full RF communication component 405. In such cases, the Rx-only RF communication component 410 may perform one or more signal processing procedures using the AFE Rx component 420-b, the AFE IF component 425-b, and/or the AFE BB component 430-b, where the remaining signal processing procedures are performed using various components of the full RF communication component 405.

In accordance with a fifth implementation 445-e, signals received by the Rx-only RF communication component 410 may be routed from an output of the ADC component 435-b of the Rx-only RF communication component 410 to the one or more digital processing components 440 of the full RF communication component 405. In such cases, the Rx-only RF communication component 410 may perform one or more signal processing procedures using the AFE Rx component 420-b, the AFE IF component 425-b, and/or the AFE BB component 430-b, and may perform an ADC procedure using the ADC component 435-b, where the remaining signal processing procedures are performed using the digital processing components 440 of the full RF communication component 405.

The various implementations 445 are associated with varying levels of complexity (and therefore cost and/or size) of the Rx-only RF communication component 410, where the first implementation 445-a is associated with the lowest level of complexity at the Rx-only RF communication component 410, and the fifth implementation 445-e is associated with the highest level of complexity at the Rx-only RF communication component 410. In this regard, the various implementations 445 may be selected based on the size/cost considerations of the Rx-only RF communication component 410.

In some cases, the quality/complexity of the extra components included within the Rx-only RF communication component 410 (for example, antenna elements 415-b, AFE Rx component 420-b, AFE IF component 425-b, AFE BB component 430-b, ADC component 435-b) may not be required or expected to the same as compared to the respective components of the “main” RF module (for example, full RF communication component 405). In particular, in the context of an RF sensing procedure, sensing may be expected to work in low SNR conditions due to the large processing gain of the correlation sequence (for example, FMCW of OFDM based), meaning that the complexity on the Rx side (for example, Rx-only RF communication component 410) may be less important than in other contexts. Further, the group delay of the extra receivers may not be overly important as long as it can be measured (for example, factory measured) and compensated.

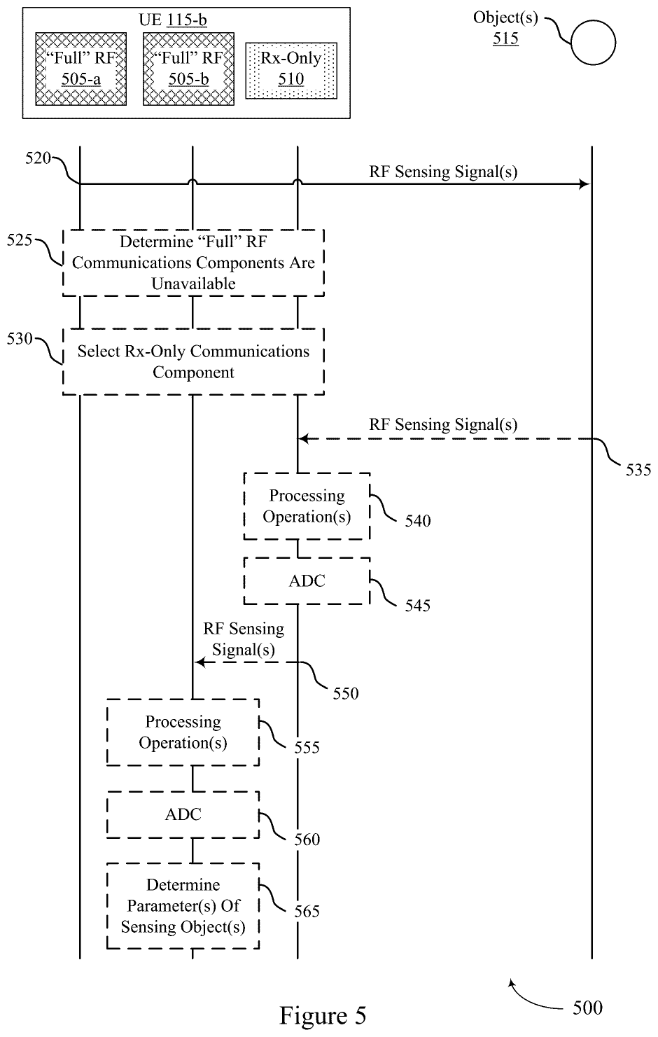

FIG. 5 shows an example of a process flow 500 that supports dedicated receiver components for mono-sensing procedures in accordance with one or more aspects of the present disclosure. In some examples, process flow 500 may implement, or be implemented by, aspects of the wireless communication system 100, the wireless communication system 200, the Tx/Rx chain 300, the Tx/Rx chain 400, or any combination thereof. For example, the process flow 500 may illustrate a UE 115-b performing an RF sensing procedure for detecting/tracking one or more objects 515 using a “full” RF communication component 505-a and an “Rx-only” RF communication component 510, as described with reference to FIGS. 1-4.

The UE 115-b illustrated in the process flow 500 may be an example of corresponding wireless communication devices (for example, UEs 115, IAB nodes, CPEs, etc.) as described herein. For example, the UE 115-b illustrated in FIG. 5 may be an example of the UE 115-a illustrated in FIG. 2. In this regard, the first full RF communication component 505-a and the second full RF communication component 505-b illustrated in FIG. 5 may be examples of the first full RF communication component 225-a and the second full RF communication component 225-b, respectively, as illustrated in FIG. 2. Similarly, the Rx-only RF communication component 510 may be an example of the Rx-only RF communication component 230-a illustrated in FIG. 2. In this regard, as described herein, the Rx-only RF communication component 510 may include one or more antenna elements for receiving RF signals, and may not be usable for transmitting RF signals. In some aspects, the UE 115-b illustrated in FIG. 5 may be configured to perform RF sensing procedures for the detection of one or more objects, including an object 515.

In some examples, the operations illustrated in process flow 500 may be performed by hardware (for example, including circuitry, processing blocks, logic components, and other components), code (for example, software or firmware) executed by a processor, or any combination thereof. Alternative examples of the following may be implemented, where some steps are performed in a different order than described or are not performed at all. In some cases, steps may include additional features not mentioned below, or further steps may be added.

At 520, the UE 115-b may transmit one or more sensing signals using the first RF communication component 505-a. As noted previously herein, the UE 115-b may transmit the sensing signals as part of an RF sensing procedure for detecting/tracking one or more objects 515.

At 525, the UE 115-b may determine that other “full” RF communication components 505-b are unavailable for performing the RF sensing procedure. For example, the UE 115-b may determine that the second “full” RF communication component 505-b is unavailable for performing the RF sensing procedure. For instance, if the UE 115-b is laying down on a table, the second RF communication component 505-b may be obstructed from receiving signals, and the UE 115-b may therefore determine that the second RF communication component 505-b is unavailable for the RF sensing procedure.

The UE 115-b may determine that the second RF communication component 505-b is unavailable based on any number of parameters, including a location of the object 515, a location of the second RF communication component 505-b on/within the UE 115-b, an orientation of the second RF communication component 505-b relative to the object 515 (for example, whether the second RF communication component 505-b is “facing” the object 515), a signal strength/quality of the sensing signals received at the second RF communication component 505-b, a self-interference level associated with signals received at the second RF communication component 505-b (for example, if self-interference exceeds some threshold level), or any combination thereof. Additionally, or alternatively, the UE 115-b may determine that the second RF communication component 505-b is unavailable for the RF sensing procedure based on the second RF communication component 505-b being used for other communications, for another RF sensing/proximity sensing procedure, based on the UE 115-b operating in a power saving mode, or any combination thereof.

At 530, the UE 115-b may select an Rx-only RF communication component 510 that will be used for the RF sensing procedure. In particular, the UE 115-b may select (and activate/trigger) which Rx-only RF communication component 510 will be used for the RF sensing procedure based on determining that other “full” RF communication components 505 (for example, second RF communication component 505-b) are unavailable for the RF sensing procedure.

In cases where the UE 115-b includes multiple Rx-only RF communication components 510, the UE 115-b may select which one will be used for the RF sensing procedure based on a number of parameters or factors, including a distance between the first RF communication component 505-a and the respective Rx-only RF communication components 510, signal leakage metrics between the first RF communication component 505-a and the respective Rx-only RF communication components 510, a location of the object 515, a location of the respective Rx-only RF communication components 510 on/within the UE 115-b, an orientation of the respective Rx-only RF communication components 510 relative to the object 515 (for example, whether the Rx-only RF communication components 510 are “facing” or “exposed to” the object 515), a signal strength/quality of the sensing signals received at the respective Rx-only RF communication components 510, a self-interference level associated with signals received at the respective Rx-only RF communication components 510, or any combination thereof.

For example, in some cases, the UE 115-b may select the Rx-only RF communication component 510 that exhibits the highest spatial separation (for example, largest distance) relative to the first RF communication component 505-a, and/or the Rx-only RF communication component 510 that exhibits the best signal quality and/or lowest signal leakage metric.

In some cases, in order to select which Rx-only RF communication component 510 will be used, the UE 115-b may reference some data object (for example, table) that includes RF sensing parameters between the first RF communication component 505-a and the respective Rx-only RF communication components 510. For example, during some previous “calibration” session or “RF training procedure,” the UE 115-b may transmit and receive RF signals (for example, RF sensing signals) using various combinations of RF communication components 505, Tx beams, and Rx-only RF communication components 510. In such cases, the UE 115-b may observe signal strength/quality metrics, signal leakage metrics, and the like, across the various combinations of RF modules. As such, the UE 115-b may generate a table or other data object that includes RF sensing parameters for various combinations of RF communication components 505 and Rx-only RF communication components 510, including distances between the respective components, signal leakage metrics, signal strength/quality metrics (for example, on a per-Tx beam basis), and the like. As such, the UE 115-b may determine which full RF communication component 505 is being used for the RF sensing procedure (and/or which Tx beam is used), and may use this information to reference a previously-created data object to determine which Rx-only RF communication component 510 should be used.

Moreover, in some cases, the UE 115-b may be configured to use different Rx-only RF communication components 510 during different times/duration throughout the RF sensing procedure. In particular, as the object 515 moves relative to the UE 115-b (and/or as the UE 115-b moves relative to the object 515), the UE 115-b may be configured to use different Tx beams at the first RF communication component 505-a (and/or use different RF communication components 505 altogether) to transmit the RF sensing signals. In such cases, the relative quality of signals received at the respective Rx-only RF communication components 510 may change throughout the RF sensing procedure.

As such, the UE 115-b may be configured to periodically (and/or aperiodically) evaluate which Rx-only RF communication component 510 should be used/activated for the RF sensing procedure. The UE 115-b may “know” (for example, in advance) which Rx-only RF communication component 510 should be used based on which Tx beams and/or which RF communication component 505 is used to transmit the sensing signals. Additionally, or alternatively, the UE 115-b may select an Rx-only RF communication component 510, and may subsequently evaluate at regular or irregular intervals whether to switch to a different Rx-only RF communication component 510. For instance, the UE 115-b may activate/trigger a new Rx-only RF communication component 510 that will be used for the RF sensing procedure if a signal strength of the sensing signals received at the currently-activated Rx-only RF communication component 510 drops below a threshold strength/quality. In such cases, the UE 115-b may be configured to receive separate subsets of RF sensing signals using different Rx-only RF communication components 510.

At 535, the UE 115-b may receive the RF sensing signals 535 that are reflected/refracted off the object 515 using the Rx-only RF communication component 510. In particular, in some cases, the UE 115-b may receive the sensing signals at 535 based on transmitting the sensing signals at 520, determining that the other “full” RF communication components are unavailable at 525, selecting the Rx-only RF communication component 510 at 530, or any combination thereof.

While the steps/operations shown at 525 and 530 are shown and described as occurring prior to receiving the RF sensing signals at 535, this is not to be regarded as a limitation of the present disclosure, unless noted otherwise herein. In particular, in some cases, the UE 115-b may receive the sensing signals at 535 using multiple different RF modules (for example, second full RF communication component 505-b, one or more Rx-only RF communication components 510), where measurements/determinations made based on the received sensing signals 535 are used to perform the determinations/selections at 525 and 530.

For example, the UE 115-b may receive the sensing signals at 535 using the second RF communication component 505-b, and may determine that the second RF communication component 505-b is unavailable (at 525) based on measurements performed on the sensing signals received at the second RF communication component 505-b. By way of another example, the UE 115-b may receive the sensing signals at 535 using multiple Rx-only RF communication components 510, and may select which Rx-only RF communication component 510 will be used (at 530) based on measurements performed on the sensing signals received at the respective Rx-only RF communication components 510.

At 540, the UE 115-b may perform one or more signal processing operations on the received RF sensing signals using one or more components of the Rx-only RF communication component 510. For example, as shown and described in FIG. 4, the UE 115-b may perform one or more signal processing operations on received RF sensing signals using an AFE Rx component 420-b, an AFE IF component 425-b, an AFE BB component 430-b, or any combination thereof. The type of signal processing operations performed by the Rx-only RF communication component 510 may depend on the type/complexity of the Rx-only RF communication component 510, and may therefore depend on which implementation 445 is used at the UE 115-b.

At 545, the UE 115-b may perform an ADC operation on the received RF sensing signals using the Rx-only RF communication component 510. For example, as shown and described in FIG. 4, the UE 115-b may perform an ADC operation on the received RF sensing signals using an ADC component 435-b.

As noted previously herein, the steps shown and described at 540 and 545 may or may not be performed by the Rx-only RF communication component 510 based on the complexity of the Rx-only RF communication component 510 (for example, based on which implementation 445 is used, and/or what components are included within the Rx-only RF communication component 510). For example, in cases in which the Rx-only RF communication component 510 does not include any processing components (for example, Rx-only RF communication component 510 does not include an AFE Rx component 420-b, an AFE IF component 425-b, an AFE BB component 430-b, an ADC component 435-b, or any combination thereof), the UE 115-b may be unable to perform any signal processing and/or ADC procedures on the received signals using the Rx-only RF communication component 510. Accordingly, in such cases, the process flow 500 may proceed from 535 directly to 550.

At 550, the UE 115-b may rout (for example, direct, relay, transmit) the received RF sensing signals from the Rx-only RF communication component 510 to the second RF communication component 505-b. That is, the UE 115-b may rout the sensing signals to another “full” RF communication component 505-b that is not being used to transmit the sensing signals for the RF sensing procedure. The UE 115-b may rout the signals from the Rx-only RF communication component 510 to the second RF communication component 505-b at 550 based on transmitting the sensing signals with the first RF communication component 505-a at 520, determining that the second RF communication component 505-b is unavailable at 525, selecting the Rx-only RF communication component 510 at 530, receiving the RF sensing signals at 535, performing the one or more processing operations using the Rx-only RF communication component 510 at 540, performing the ADC operation using the Rx-only RF communication component 510 at 545, or any combination thereof.

As described in FIG. 4, the components/procedure for routing the signals from the Rx-only RF communication component 510 to the RF communication component 505-b may depend on the implementation 445 that is used. For example, in cases in which the first implementation 445-a is used, the sensing signals may be routed from an output of the antenna elements 415-b of the Rx-only RF communication component 510 to an input of the AFE Rx component 420-a of the full RF communication component 505-b. Comparatively, in cases in which the second implementation 445-b is used, the sensing signals may be routed from an output of the AFE Rx component 420-b of the Rx-only RF communication component 510 to an input of the AFE IF component 425-a of the full RF communication component 505-b. In this regard, the UE 115-b may rout the sensing signals to the RF communication component 505-b for additional processing based on which components are included (or are not included) within the Rx-only RF communication component 510.

At 555, the UE 115-b may perform one or more signal processing operations on the received RF sensing signals using one or more components of the second full RF communication component 505-b. In particular, the second RF communication component 505-b may perform one or more signal processing operations that were not performed by the Rx-only RF communication component 510. For example, as shown and described in FIG. 4, the UE 115-b may perform one or more signal processing operations on received RF sensing signals using an AFE Rx component 420-a, an AFE IF component 425-a, an AFE BB component 430-a, digital processing components 440, or any combination thereof.

At 560, the UE 115-b may perform an ADC operation on the received RF sensing signals using the second full RF communication component 505-b. For example, as shown and described in FIG. 4, the UE 115-b may perform an ADC operation on the received RF sensing signals using an ADC component 435-a.

At 565, the UE 115-b may determine one or more parameters of the object 515 as part of the RF sensing procedure. For example, the UE 115-b may determine a location, size, shape, heading, velocity/speed, etc., of the object 515. The UE 115-b may determine the one or more parameters of the object 515 as part of the RF sensing procedure based on transmitting the RF sensing signals at 520, determining that the second RF communication component 505-b is unavailable at 525, selecting the Rx-only RF communication component 510 at 530, receiving the RF sensing signals at 535, performing the one or more processing operations at 540 and/or 555, performing the ADC operation at 545 or 560, routing the sensing signals to the second RF communication component 505-b at 550, or any combination thereof.

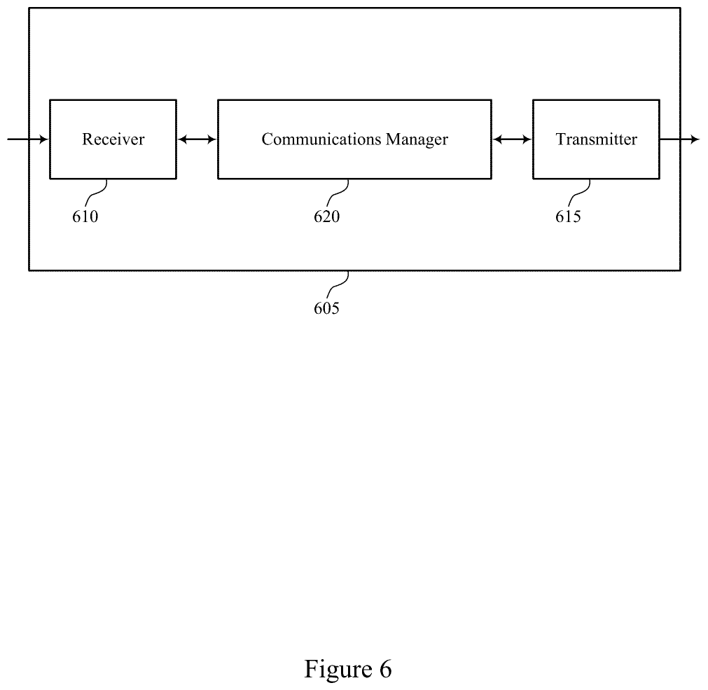

FIG. 6 shows a block diagram of a device 605 that supports dedicated receiver components for mono-sensing procedures in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to dedicated receiver components for mono-sensing procedures). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to dedicated receiver components for mono-sensing procedures). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of dedicated receiver components for mono-sensing procedures as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for transmitting one or more sensing signals, associated with an RF sensing procedure, using a first RF communication component from a first set of one or more RF communication components that are each associated with transmitting and receiving RF signals. The communications manager 620 is capable of, configured to, or operable to support a means for selecting, in association with one or more of the first set of one or more RF communication components being unavailable for the RF sensing procedure, a second RF communication component from a second set of one or more RF communication components that are each associated with receiving RF signals and not associated with transmitting RF signals. The communications manager 620 is capable of, configured to, or operable to support a means for receiving one or more reflections of the one or more sensing signals using the second RF communication component.

By including or configuring the communication manager 620 in accordance with examples as described herein, the device 605 (for example, at least one processor controlling or otherwise coupled with the receiver 610, the transmitter 615, the communication manager 620, or a combination thereof) may support techniques for smaller and more cost-efficient Rx-only RF communication components (Rx-only RF modules) that may be used for various communications and procedures, such as RF sensing procedures. Implementing one (or more) Rx-only RF communication components in a device may provide additional components/modules that may be used for RF sensing procedures, thereby enabling wireless communication devices to perform RF sensing procedures even in cases where “full” RF communication components are blocked or otherwise unavailable.

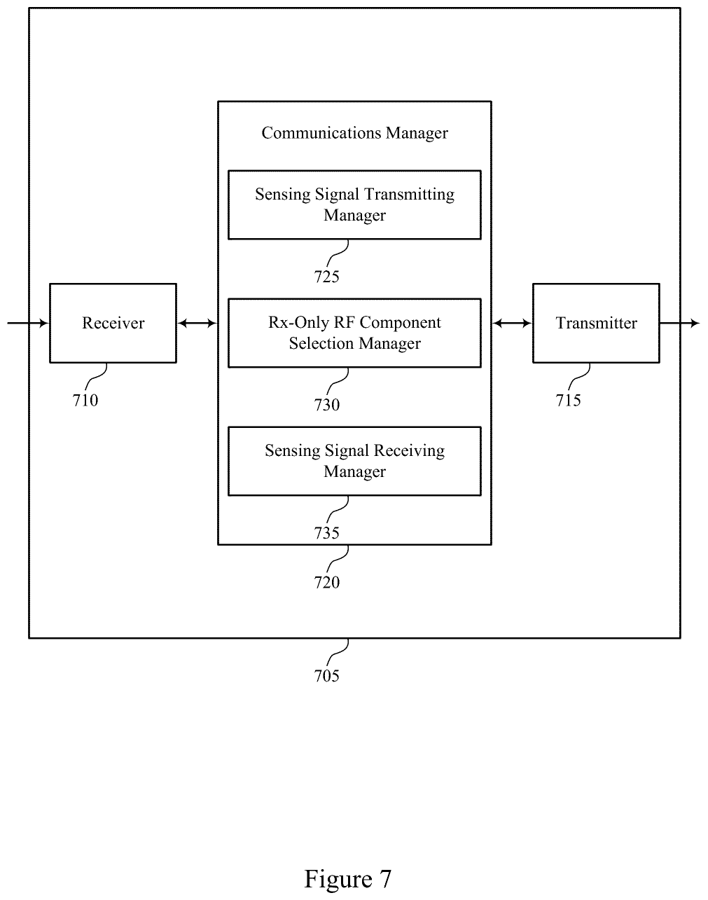

FIG. 7 shows a block diagram of a device 705 that supports dedicated receiver components for mono-sensing procedures in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to dedicated receiver components for mono-sensing procedures). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to dedicated receiver components for mono-sensing procedures). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of dedicated receiver components for mono-sensing procedures as described herein. For example, the communications manager 720 may include a sensing signal transmitting manager 725, a Rx-only RF component selection manager 730, a sensing signal receiving manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The sensing signal transmitting manager 725 is capable of, configured to, or operable to support a means for transmitting one or more sensing signals, associated with an RF sensing procedure, using a first RF communication component from a first set of one or more RF communication components that are each associated with transmitting and receiving RF signals. The Rx-only RF component selection manager 730 is capable of, configured to, or operable to support a means for selecting, in association with one or more of the first set of one or more RF communication components being unavailable for the RF sensing procedure, a second RF communication component from a second set of one or more RF communication components that are each associated with receiving RF signals and not associated with transmitting RF signals. The sensing signal receiving manager 735 is capable of, configured to, or operable to support a means for receiving one or more reflections of the one or more sensing signals using the second RF communication component.

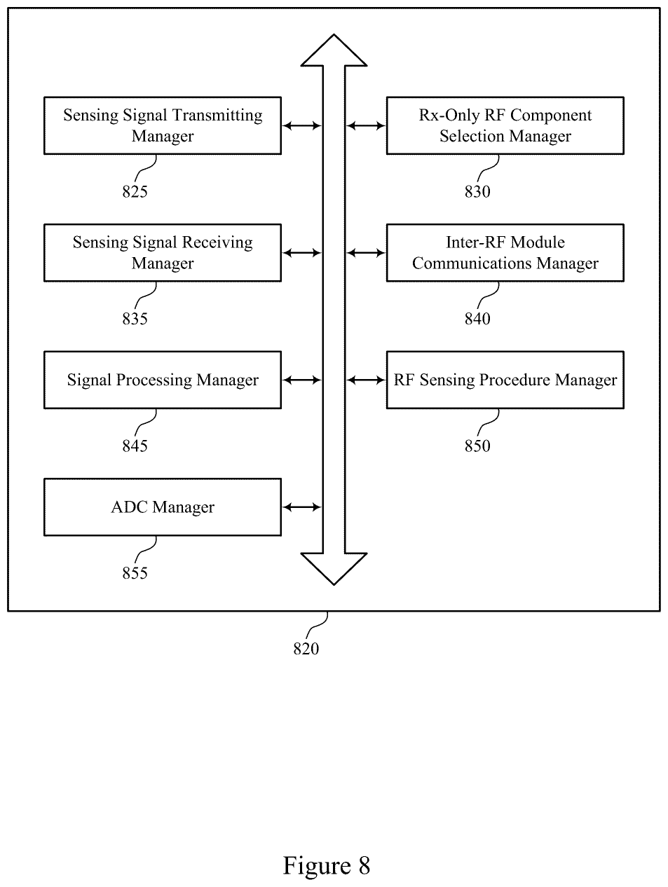

FIG. 8 shows a block diagram 800 of a communications manager 820 that supports dedicated receiver components for mono-sensing procedures in accordance with one or more aspects of the present disclosure. The communications manager 820 may be an example of aspects of a communications manager 620, a communications manager 720, or both, as described herein. The communications manager 820, or various components thereof, may be an example of means for performing various aspects of dedicated receiver components for mono-sensing procedures as described herein. For example, the communications manager 820 may include a sensing signal transmitting manager 825, a Rx-only RF component selection manager 830, a sensing signal receiving manager 835, an inter-RF module communications manager 840, a signal processing manager 845, an RF sensing procedure manager 850, an ADC manager 855, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The sensing signal transmitting manager 825 is capable of, configured to, or operable to support a means for transmitting one or more sensing signals, associated with an RF sensing procedure, using a first RF communication component from a first set of one or more RF communication components that are each associated with transmitting and receiving RF signals. The Rx-only RF component selection manager 830 is capable of, configured to, or operable to support a means for selecting, in association with one or more of the first set of one or more RF communication components being unavailable for the RF sensing procedure, a second RF communication component from a second set of one or more RF communication components that are each associated with receiving RF signals and not associated with transmitting RF signals. The sensing signal receiving manager 835 is capable of, configured to, or operable to support a means for receiving one or more reflections of the one or more sensing signals using the second RF communication component.

In some examples, to support selecting the second RF communication component, the Rx-only RF component selection manager 830 is capable of, configured to, or operable to support a means for selecting the second RF communication component from the second set of one or more RF communication components based on a distance between the second RF communication component and the first RF communication component, a signal leakage metric between the second RF communication component and the first RF communication component, or both.

In some examples, to support selecting the second RF communication component, the Rx-only RF component selection manager 830 is capable of, configured to, or operable to support a means for selecting the second RF communication component from the second set of one or more RF communication components of the wireless communication device based on an exposure of the second RF communication component to one or more objects detected via the RF sensing procedure.

In some examples, the one or more sensing signals are transmitted during the RF sensing procedure using a set of multiple transmit beams of the first RF communication component, and the Rx-only RF component selection manager 830 is capable of, configured to, or operable to support a means for selecting the second RF communication component from the second set of one or more RF communication components based on a first subset of transmit beams of the set of multiple transmit beams being used by the first RF communication component. In some examples, the one or more sensing signals are transmitted during the RF sensing procedure using a set of multiple transmit beams of the first RF communication component, and the sensing signal receiving manager 835 is capable of, configured to, or operable to support a means for receiving a first subset of reflections of a first subset of sensing signals of the one or more sensing signals via the second RF communication component. In some examples, the one or more sensing signals are transmitted during the RF sensing procedure using a set of multiple transmit beams of the first RF communication component, and the Rx-only RF component selection manager 830 is capable of, configured to, or operable to support a means for selecting a third RF communication component from the second set of one or more RF communication components based on a second subset of transmit beams of the set of multiple transmit beams being used by the first RF communication component. In some examples, the one or more sensing signals are transmitted during the RF sensing procedure using a set of multiple transmit beams of the first RF communication component, and the sensing signal receiving manager 835 is capable of, configured to, or operable to support a means for receiving a second subset of reflections of a second subset of sensing signals of the one or more sensing signals via the third RF communication component.

In some examples, the inter-RF module communications manager 840 is capable of, configured to, or operable to support a means for routing the one or more reflections of the one or more sensing signals from the second RF communication component to a third RF communication component of the first set of one or more RF communication components based on an absence of a processing component for processing signals at the second RF communication component, based on the wireless communication device operating in a power saving mode, or both. In some examples, the signal processing manager 845 is capable of, configured to, or operable to support a means for performing a signal processing operation on the one or more reflections of the one or more sensing signals using one or more processing components of the third RF communication components. In some examples, the RF sensing procedure manager 850 is capable of, configured to, or operable to support a means for determining one or more parameters associated with one or more objects detected via the RF sensing procedure based on the signal processing operation.

In some examples, the signal processing manager 845 is capable of, configured to, or operable to support a means for performing a first signal processing operation on the one or more reflections of the one or more sensing signals using an antenna front end component of the second RF communication component, where the one or more reflections of the one or more sensing signals are routed from the second RF communication component to the third RF communication component based on performing the first signal processing operation.

In some examples, the signal processing manager 845 is capable of, configured to, or operable to support a means for performing a second signal processing operation on the one or more reflections of the one or more sensing signals using an intermediate frequency module, a baseband component, or both, of the second RF communication component, where the second signal processing operation is performed based on performing the first signal processing operation, where the one or more reflections of the one or more sensing signals are routed from the second RF communication component to the third RF communication component based on performing the second signal processing operation.

In some examples, the ADC manager 855 is capable of, configured to, or operable to support a means for performing an analog-to-digital conversion operation on the one or more reflections of the one or more sensing signals using an analog-to-digital component of the second RF communication component and based on performing the first signal processing operation, where the one or more reflections of the one or more sensing signals are routed from the second RF communication component to the third RF communication component based on performing the analog-to-digital conversion operation.

In some examples, the RF sensing procedure manager 850 is capable of, configured to, or operable to support a means for determining that the one or more RF communication components of the first set of one or more RF communication components are unavailable for the RF sensing procedure based on a location of one or more objects detected via the RF sensing procedure, an orientation of the one or more RF communication components within the wireless communication device, or both.

In some examples, the RF sensing procedure manager 850 is capable of, configured to, or operable to support a means for determining that the one or more RF communication components of the first set of one or more RF communication components are unavailable for the RF sensing procedure based on a signal strength metric, a signal quality metric, or both, associated with signals received by the one or more RF communication components.

In some examples, the RF sensing procedure manager 850 is capable of, configured to, or operable to support a means for determining that the one or more RF communication components of the first set of one or more RF communication components are unavailable for the RF sensing procedure based on the one or more RF communication components being used for other wireless communication, another RF sensing procedure, a proximity sensing procedure, or any combination thereof.

In some examples, the RF sensing procedure manager 850 is capable of, configured to, or operable to support a means for determining that the one or more RF communication components of the first set of one or more RF communication components are unavailable for the RF sensing procedure based on a self-interference level associated with the one or more reflections of the one or more sensing signals received at the one or more RF communication components exceeding a threshold level.

In some examples, the RF sensing procedure is performed at a second time, and the sensing signal transmitting manager 825 is capable of, configured to, or operable to support a means for transmitting additional sensing signals using the first RF communication component at a first time prior to the second time. In some examples, the RF sensing procedure is performed at a second time, and the sensing signal receiving manager 835 is capable of, configured to, or operable to support a means for receiving reflections of the additional sensing signals at each of the second set of one or more RF communication components including the second RF communication component. In some examples, the RF sensing procedure is performed at a second time, and the RF sensing procedure manager 850 is capable of, configured to, or operable to support a means for generating a data object including RF sensing parameters between the first RF communication component and the second set of one or more RF communication components, where the second RF communication component is selected from the second set of one or more RF communication components based on referencing the data object.

In some examples, the second RF communication component includes one or more antenna elements for receiving RF signals. In some examples, the second RF communication component is not usable for transmitting RF signals.

In some examples, the wireless communication device includes a UE, an integrated access and backhaul (IAB) node, a customer premises equipment (CPE), or any combination thereof.

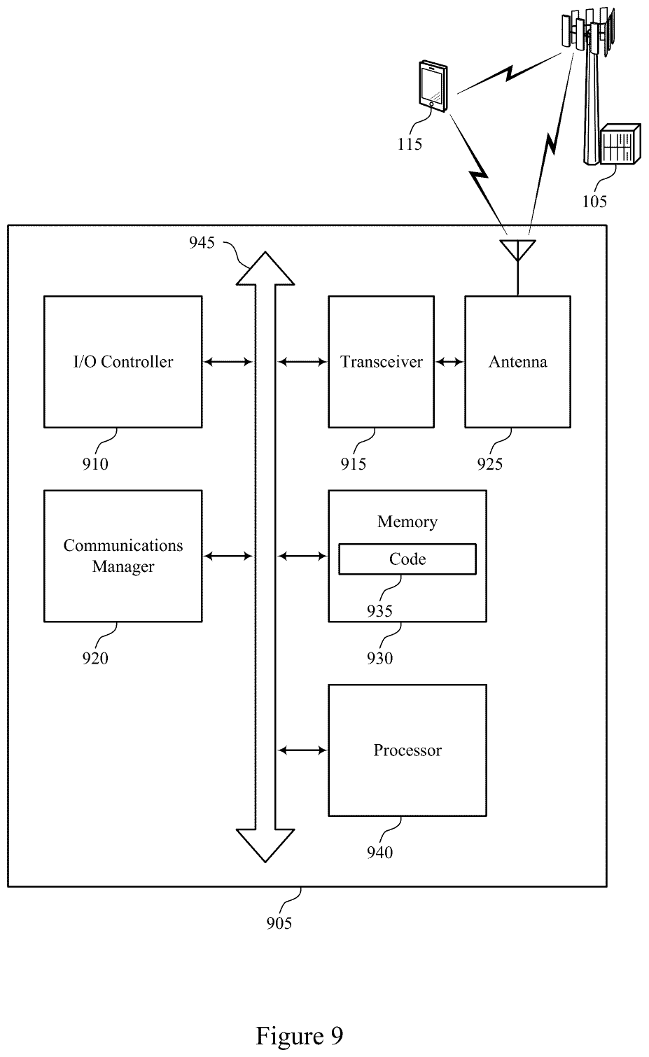

FIG. 9 shows a diagram of a system including a device 905 that supports dedicated receiver components for mono-sensing procedures in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting dedicated receiver components for mono-sensing procedures). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for transmitting one or more sensing signals, associated with an RF sensing procedure, using a first RF communication component from a first set of one or more RF communication components that are each associated with transmitting and receiving RF signals. The communications manager 920 is capable of, configured to, or operable to support a means for selecting, in association with one or more of the first set of one or more RF communication components being unavailable for the RF sensing procedure, a second RF communication component from a second set of one or more RF communication components that are each associated with receiving RF signals and not associated with transmitting RF signals. The communications manager 920 is capable of, configured to, or operable to support a means for receiving one or more reflections of the one or more sensing signals using the second RF communication component.

By including or configuring the communication manager 920 in accordance with examples as described herein, the device 905 may support techniques for smaller and more cost-efficient Rx-only RF communication components (Rx-only RF modules) that may be used for various communications and procedures, such as RF sensing procedures. Implementing one (or more) Rx-only RF communication components in a device may provide additional components/modules that may be used for RF sensing procedures, thereby enabling wireless communication devices to perform RF sensing procedures even in cases where “full” RF communication components are blocked or otherwise unavailable.

In some examples, the communication manager 920 may be configured to perform various operations (for example, receiving, monitoring, transmitting) using or otherwise in cooperation with the transceiver 915, the one or more antennas 925, or any combination thereof. Although the communication manager 920 is illustrated as a separate component, in some examples, one or more functions described with reference to the communication manager 920 may be supported by or performed by the at least one processor 940, the at least one memory 930, the code 935, or any combination thereof. For example, the code 935 may include instructions executable by the at least one processor 940 to cause the device 905 to perform various aspects of dedicated receiver components for mono-sensing procedures as described herein, or the at least one processor 940 and the at least one memory 930 may be otherwise configured to, individually or collectively, perform or support such operations.

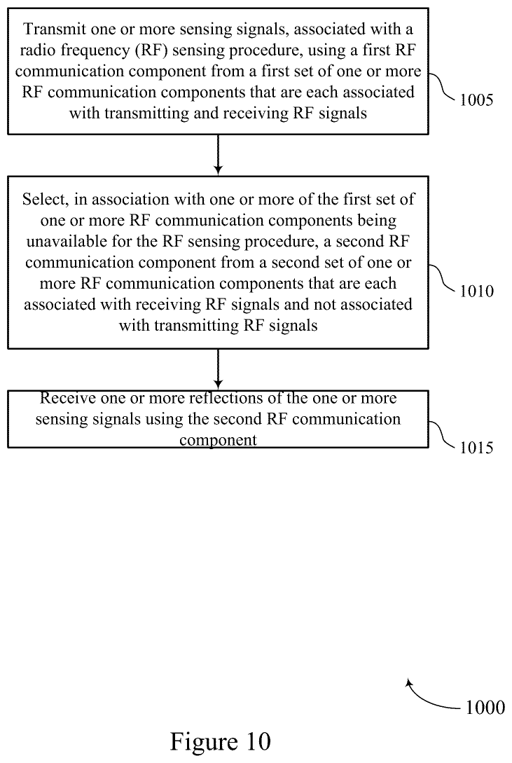

FIG. 10 shows a flowchart illustrating a method 1000 that supports dedicated receiver components for mono-sensing procedures in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include transmitting one or more sensing signals, associated with an RF sensing procedure, using a first RF communication component from a first set of one or more RF communication components that are each associated with transmitting and receiving RF signals. The operations of block 1005 may be performed in accordance with examples as disclosed herein. In some examples, aspects of the operations of 1005 may be performed by a sensing signal transmitting manager 825 as described with reference to FIG. 8.

At 1010, the method may include selecting, in association with one or more of the first set of one or more RF communication components being unavailable for the RF sensing procedure, a second RF communication component from a second set of one or more RF communication components that are each associated with receiving RF signals and not associated with transmitting RF signals. The operations of block 1010 may be performed in accordance with examples as disclosed herein. In some examples, aspects of the operations of 1010 may be performed by a Rx-only RF component selection manager 830 as described with reference to FIG. 8.

At 1015, the method may include receiving one or more reflections of the one or more sensing signals using the second RF communication component. The operations of block 1015 may be performed in accordance with examples as disclosed herein. In some examples, aspects of the operations of 1015 may be performed by a sensing signal receiving manager 835 as described with reference to FIG. 8.

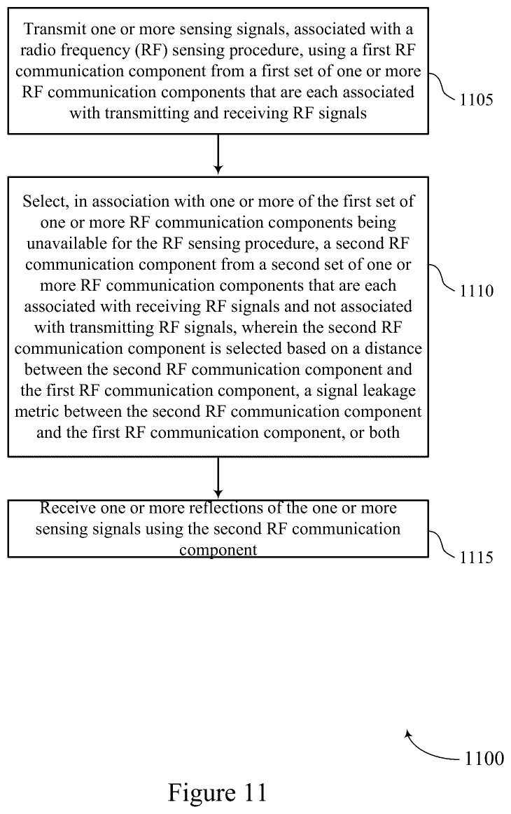

FIG. 11 shows a flowchart illustrating a method 1100 that supports dedicated receiver components for mono-sensing procedures in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include transmitting one or more sensing signals, associated with an RF sensing procedure, using a first RF communication component from a first set of one or more RF communication components that are each associated with transmitting and receiving RF signals. The operations of block 1105 may be performed in accordance with examples as disclosed herein. In some examples, aspects of the operations of 1105 may be performed by a sensing signal transmitting manager 825 as described with reference to FIG. 8.

At 1110, the method may include selecting, in association with one or more of the first set of one or more RF communication components being unavailable for the RF sensing procedure, a second RF communication component from a second set of one or more RF communication components that are each associated with receiving RF signals and not associated with transmitting RF signals, where the second RF communication component is selected based on a distance between the second RF communication component and the first RF communication component, a signal leakage metric between the second RF communication component and the first RF communication component, or both. The operations of block 1110 may be performed in accordance with examples as disclosed herein. In some examples, aspects of the operations of 1110 may be performed by a Rx-only RF component selection manager 830 as described with reference to FIG. 8.

At 1115, the method may include receiving one or more reflections of the one or more sensing signals using the second RF communication component. The operations of block 1115 may be performed in accordance with examples as disclosed herein. In some examples, aspects of the operations of 1115 may be performed by a sensing signal receiving manager 835 as described with reference to FIG. 8.

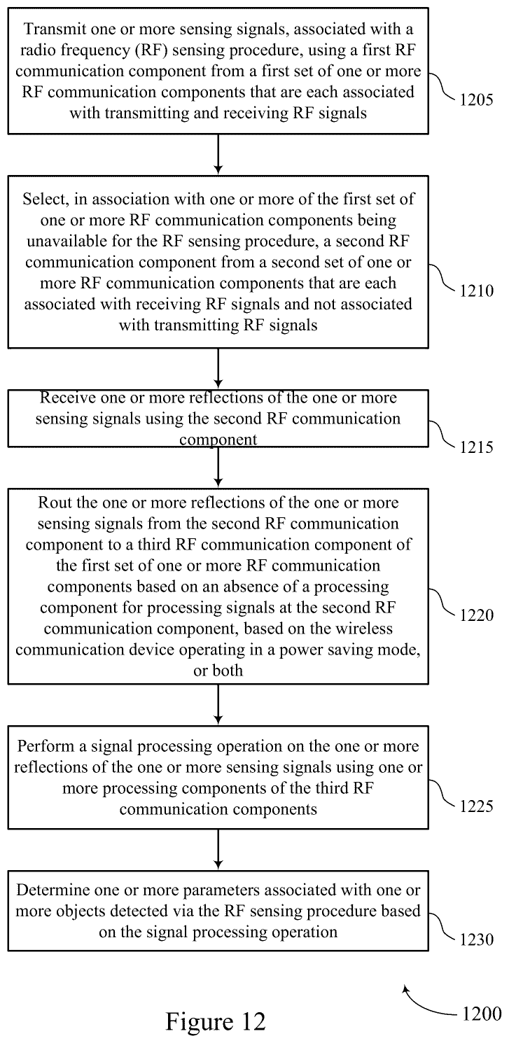

FIG. 12 shows a flowchart illustrating a method 1200 that supports dedicated receiver components for mono-sensing procedures in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include transmitting one or more sensing signals, associated with an RF sensing procedure, using a first RF communication component from a first set of one or more RF communication components that are each associated with transmitting and receiving RF signals. The operations of block 1205 may be performed in accordance with examples as disclosed herein. In some examples, aspects of the operations of 1205 may be performed by a sensing signal transmitting manager 825 as described with reference to FIG. 8.

At 1210, the method may include selecting, in association with one or more of the first set of one or more RF communication components being unavailable for the RF sensing procedure, a second RF communication component from a second set of one or more RF communication components that are each associated with receiving RF signals and not associated with transmitting RF signals. The operations of block 1210 may be performed in accordance with examples as disclosed herein. In some examples, aspects of the operations of 1210 may be performed by a Rx-only RF component selection manager 830 as described with reference to FIG. 8.

At 1215, the method may include receiving one or more reflections of the one or more sensing signals using the second RF communication component. The operations of block 1215 may be performed in accordance with examples as disclosed herein. In some examples, aspects of the operations of 1215 may be performed by a sensing signal receiving manager 835 as described with reference to FIG. 8.

At 1220, the method may include routing the one or more reflections of the one or more sensing signals from the second RF communication component to a third RF communication component of the first set of one or more RF communication components based on an absence of a processing component for processing signals at the second RF communication component, based on the wireless communication device operating in a power saving mode, or both. The operations of block 1220 may be performed in accordance with examples as disclosed herein. In some examples, aspects of the operations of 1220 may be performed by an inter-RF module communications manager 840 as described with reference to FIG. 8.

At 1225, the method may include performing a signal processing operation on the one or more reflections of the one or more sensing signals using one or more processing components of the third RF communication components. The operations of block 1225 may be performed in accordance with examples as disclosed herein. In some examples, aspects of the operations of 1225 may be performed by a signal processing manager 845 as described with reference to FIG. 8.

At 1230, the method may include determining one or more parameters associated with one or more objects detected via the RF sensing procedure based on the signal processing operation. The operations of block 1230 may be performed in accordance with examples as disclosed herein. In some examples, aspects of the operations of 1230 may be performed by an RF sensing procedure manager 850 as described with reference to FIG. 8.

The following provides an overview of aspects of the present disclosure:

Aspect 1: A method for wireless communication at a wireless communication device, comprising: transmitting one or more sensing signals, associated with an RF sensing procedure, using a first RF communication component from a first set of one or more RF communication components that are each associated with transmitting and receiving RF signals; selecting, in association with one or more of the first set of one or more RF communication components being unavailable for the RF sensing procedure, a second RF communication component from a second set of one or more RF communication components that are each associated with receiving RF signals and not associated with transmitting RF signals; and receiving one or more reflections of the one or more sensing signals using the second RF communication component.

Aspect 2: The method of aspect, wherein selecting the second RF communication component comprises: selecting the second RF communication component from the second set of one or more RF communication components based at least in part on a distance between the second RF communication component and the first RF communication component, a signal leakage metric between the second RF communication component and the first RF communication component, or both.

Aspect 3: The method of aspect, wherein selecting the second RF communication component comprises: selecting the second RF communication component from the second set of one or more RF communication components of the wireless communication device based at least in part on an exposure of the second RF communication component to one or more objects detected via the RF sensing procedure.

Aspect 4: The method of any of aspects through, wherein the one or more sensing signals are transmitted during the RF sensing procedure using a plurality of transmit beams of the first RF communication component, wherein, to select the second RF communication component, the method further comprising: selecting the second RF communication component from the second set of one or more RF communication components based at least in part on a first subset of transmit beams of the plurality of transmit beams being used by the first RF communication component; receiving a first subset of reflections of a first subset of sensing signals of the one or more sensing signals via the second RF communication component; selecting a third RF communication component from the second set of one or more RF communication components based at least in part on a second subset of transmit beams of the plurality of transmit beams being used by the first RF communication component; and receiving a second subset of reflections of a second subset of sensing signals of the one or more sensing signals via the third RF communication component.

Aspect 5: The method of any of aspects through, further comprising: routing the one or more reflections of the one or more sensing signals from the second RF communication component to a third RF communication component of the first set of one or more RF communication components based at least in part on an absence of a processing component for processing signals at the second RF communication component, based at least in part on the wireless communication device operating in a power saving mode, or both; performing a signal processing operation on the one or more reflections of the one or more sensing signals using one or more processing components of the third RF communication components; and determining one or more parameters associated with one or more objects detected via the RF sensing procedure based at least in part on the signal processing operation.

Aspect 6: The method of aspect, further comprising: performing a first signal processing operation on the one or more reflections of the one or more sensing signals using an antenna front end component of the second RF communication component, wherein the one or more reflections of the one or more sensing signals are routed from the second RF communication component to the third RF communication component based at least in part on performing the first signal processing operation.

Aspect 7: The method of aspect, further comprising: performing a second signal processing operation on the one or more reflections of the one or more sensing signals using an intermediate frequency module, a baseband component, or both, of the second RF communication component, wherein the second signal processing operation is performed based at least in part on performing the first signal processing operation, wherein the one or more reflections of the one or more sensing signals are routed from the second RF communication component to the third RF communication component based at least in part on performing the second signal processing operation.

Aspect 8: The method of any of aspects through, further comprising: performing an analog-to-digital conversion operation on the one or more reflections of the one or more sensing signals using an analog-to-digital component of the second RF communication component and based at least in part on performing the first signal processing operation, wherein the one or more reflections of the one or more sensing signals are routed from the second RF communication component to the third RF communication component based at least in part on performing the analog-to-digital conversion operation.

Aspect 9: The method of any of aspects through, further comprising: determining that the one or more RF communication components of the first set of one or more RF communication components are unavailable for the RF sensing procedure based at least in part on a location of one or more objects detected via the RF sensing procedure, an orientation of the one or more RF communication components within the wireless communication device, or both.

Aspect 10: The method of any of aspects through, further comprising: determining that the one or more RF communication components of the first set of one or more RF communication components are unavailable for the RF sensing procedure based at least in part on a signal strength metric, a signal quality metric, or both, associated with signals received by the one or more RF communication components.

Aspect 11: The method of any of aspects through, further comprising: determining that the one or more RF communication components of the first set of one or more RF communication components are unavailable for the RF sensing procedure based at least in part on the one or more RF communication components being used for other wireless communication, another RF sensing procedure, a proximity sensing procedure, or any combination thereof.

Aspect 12: The method of any of aspects through, further comprising: determining that the one or more RF communication components of the first set of one or more RF communication components are unavailable for the RF sensing procedure based at least in part on a self-interference level associated with the one or more reflections of the one or more sensing signals received at the one or more RF communication components exceeding a threshold level.

Aspect 13: The method of any of aspects through, wherein the RF sensing procedure is performed at a second time, the method further comprising: transmitting additional sensing signals using the first RF communication component at a first time prior to the second time; receiving reflections of the additional sensing signals at each of the second set of one or more RF communication components including the second RF communication component; and generating a data object comprising RF sensing parameters between the first RF communication component and the second set of one or more RF communication components, wherein the second RF communication component is selected from the second set of one or more RF communication components based at least in part on referencing the data object.

Aspect 14: The method of any of aspects through, wherein the second RF communication component comprises one or more antenna elements for receiving RF signals, and the second RF communication component is not usable for transmitting RF signals.

Aspect 15: The method of any of aspects through, wherein the wireless communication device comprises a UE, an integrated access and backhaul (IAB) node, a customer premises equipment (CPE), or any combination thereof.

Aspect 16: A wireless communication device for wireless communication, comprising one or more memories storing processor-executable code, and one or more processors coupled with the one or more memories and individually or collectively operable to execute the code to cause the wireless communication device to perform a method of any of aspects through.

Aspect 17: A wireless communication device for wireless communication, comprising at least one means for performing a method of any of aspects through.

Aspect 18: A non-transitory computer-readable medium storing code for wireless communication, the code comprising instructions executable by one or more processors to perform a method of any of aspects through.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (for example, receiving information), accessing (for example, accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless communication device, comprising:
a processing system that includes processor circuitry and memory circuitry that stores code, the processing system configured to cause the wireless communication device to:
transmit one or more sensing signals, associated with a radio frequency (RF) sensing procedure, using a first RF communication component from a first set of one or more RF communication components that are each associated with transmitting and receiving RF signals;
select, in association with one or more of the first set of one or more RF communication components being unavailable for the RF sensing procedure, a second RF communication component from a second set of one or more RF communication components that are each associated with receiving RF signals and not associated with transmitting RF signals; and
receive one or more reflections of the one or more sensing signals using the second RF communication component.

2. The wireless communication device of claim 1, wherein, to select the second RF communication component, the processing system is configured to cause the wireless communication device to:
select the second RF communication component from the second set of one or more RF communication components based at least in part on a distance between the second RF communication component and the first RF communication component, a signal leakage metric between the second RF communication component and the first RF communication component, or both.

3. The wireless communication device of claim 2, wherein, to select the second RF communication component, the processing system is configured to cause the wireless communication device to:
select the second RF communication component from the second set of one or more RF communication components of the wireless communication device based at least in part on an exposure of the second RF communication component to one or more objects detected via the RF sensing procedure.

4. The wireless communication device of claim 1, wherein the one or more sensing signals are transmitted during the RF sensing procedure using a plurality of transmit beams of the first RF communication component, wherein, to select the second RF communication component, the processing system is configured to cause the wireless communication device to:
select the second RF communication component from the second set of one or more RF communication components based at least in part on a first subset of transmit beams of the plurality of transmit beams being used by the first RF communication component;
receive a first subset of reflections of a first subset of sensing signals of the one or more sensing signals via the second RF communication component;
select a third RF communication component from the second set of one or more RF communication components based at least in part on a second subset of transmit beams of the plurality of transmit beams being used by the first RF communication component; and
receive a second subset of reflections of a second subset of sensing signals of the one or more sensing signals via the third RF communication component.

5. The wireless communication device of claim 1, wherein the processing system is further configured to cause the wireless communication device to:
rout the one or more reflections of the one or more sensing signals from the second RF communication component to a third RF communication component of the first set of one or more RF communication components based at least in part on an absence of a processing component for processing signals at the second RF communication component, based at least in part on the wireless communication device operating in a power saving mode, or both;
perform a signal processing operation on the one or more reflections of the one or more sensing signals using one or more processing components of the third RF communication components; and
determine one or more parameters associated with one or more objects detected via the RF sensing procedure based at least in part on the signal processing operation.

6. The wireless communication device of claim 5, wherein the processing system is further configured to cause the wireless communication device to:
perform a first signal processing operation on the one or more reflections of the one or more sensing signals using an antenna front end component of the second RF communication component, wherein the one or more reflections of the one or more sensing signals are routed from the second RF communication component to the third RF communication component based at least in part on performing the first signal processing operation.

7. The wireless communication device of claim 6, wherein the processing system is further configured to cause the wireless communication device to:
perform a second signal processing operation on the one or more reflections of the one or more sensing signals using an intermediate frequency module, a baseband component, or both, of the second RF communication component, wherein the second signal processing operation is performed based at least in part on performing the first signal processing operation, wherein the one or more reflections of the one or more sensing signals are routed from the second RF communication component to the third RF communication component based at least in part on performing the second signal processing operation.

8. The wireless communication device of claim 6, wherein the processing system is further configured to cause the wireless communication device to:
perform an analog-to-digital conversion operation on the one or more reflections of the one or more sensing signals using an analog-to-digital component of the second RF communication component and based at least in part on performing the first signal processing operation, wherein the one or more reflections of the one or more sensing signals are routed from the second RF communication component to the third RF communication component based at least in part on performing the analog-to-digital conversion operation.

9. The wireless communication device of claim 1, wherein the processing system is further configured to cause the wireless communication device to:
determine that the one or more RF communication components of the first set of one or more RF communication components are unavailable for the RF sensing procedure based at least in part on a location of one or more objects detected via the RF sensing procedure, an orientation of the one or more RF communication components within the wireless communication device, or both.

10. The wireless communication device of claim 1, wherein the processing system is further configured to cause the wireless communication device to:
determine that the one or more RF communication components of the first set of one or more RF communication components are unavailable for the RF sensing procedure based at least in part on a signal strength metric, a signal quality metric, or both, associated with signals received by the one or more RF communication components.

11. The wireless communication device of claim 1, wherein the processing system is further configured to cause the wireless communication device to:
determine that the one or more RF communication components of the first set of one or more RF communication components are unavailable for the RF sensing procedure based at least in part on the one or more RF communication components being used for other wireless communication, another RF sensing procedure, a proximity sensing procedure, or any combination thereof.

12. The wireless communication device of claim 1, wherein the processing system is further configured to cause the wireless communication device to:
determine that the one or more RF communication components of the first set of one or more RF communication components are unavailable for the RF sensing procedure based at least in part on a self-interference level associated with the one or more reflections of the one or more sensing signals received at the one or more RF communication components exceeding a threshold level.

13. The wireless communication device of claim 1, wherein the RF sensing procedure is performed at a second time, wherein the processing system is further configured to cause the wireless communication device to:
transmit additional sensing signals using the first RF communication component at a first time prior to the second time;
receive reflections of the additional sensing signals at each of the second set of one or more RF communication components including the second RF communication component; and
generate a data object comprising RF sensing parameters between the first RF communication component and the second set of one or more RF communication components, wherein the second RF communication component is selected from the second set of one or more RF communication components based at least in part on referencing the data object.

14. The wireless communication device of claim 1, wherein the second RF communication component comprises one or more antenna elements for receiving RF signals, and wherein the second RF communication component is not usable for transmitting RF signals.

15. The wireless communication device of claim 1, wherein the wireless communication device comprises a user equipment (UE), an integrated access and backhaul (IAB) node, a customer premises equipment (CPE), or any combination thereof.

16. A method for wireless communication by a wireless communication device, comprising:
transmitting one or more sensing signals, associated with a radio frequency (RF) sensing procedure, using a first RF communication component from a first set of one or more RF communication components that are each associated with transmitting and receiving RF signals;
selecting, in association with one or more of the first set of one or more RF communication components being unavailable for the RF sensing procedure, a second RF communication component from a second set of one or more RF communication components that are each associated with receiving RF signals and not associated with transmitting RF signals; and
receiving one or more reflections of the one or more sensing signals using the second RF communication component.

17. The method of claim 16, wherein selecting the second RF communication component comprises:
selecting the second RF communication component from the second set of one or more RF communication components of the wireless communication device based at least in part on a distance between the second RF communication component and the first RF communication component, a signal leakage metric between the second RF communication component and the first RF communication component, or both.

18. The method of claim 17, wherein selecting the second RF communication component comprises:
selecting the second RF communication component from the second set of one or more RF communication components of the wireless communication device based at least in part on an exposure of the second RF communication component to the one or more objects.

19. The method of claim 16, wherein the one or more sensing signals are transmitted during the RF sensing procedure using a plurality of transmit beams at the first RF communication component, wherein selecting the second RF communication component comprises:
selecting the second RF communication component from the second set of one or more RF communication components based at least in part on a first subset of transmit beams of the plurality of transmit beams being used by the first RF communication component;
receiving a first subset of reflections of a first subset of sensing signals of the one or more sensing signals via the second RF communication component;
selecting a third RF communication component from the second set of one or more RF communication components based at least in part on a second subset of transmit beams of the plurality of transmit beams being used by the first RF communication component; and
receiving a second subset of reflections of a second subset of sensing signals of the one or more sensing signals via the third RF communication component.

20. The method of claim 16, further comprising:
routing the one or more reflections of the one or more sensing signals from the second RF communication component to a third RF communication component of the first set of one or more RF communication components based at least in part on an absence of a processing component for processing signals at the second RF communication component, based at least in part on the wireless communication device operating in a power saving mode, or both;
performing a signal processing operation on the one or more reflections of the one or more sensing signals using one or more processing components of the third RF communication component; and
determining one or more parameters associated with the one or more objects based at least in part on the signal processing operation.

21. The method of claim 20, further comprising:
performing a first signal processing operation on the one or more reflections of the one or more sensing signals using an antenna front end component of the second RF communication component, wherein the one or more reflections of the one or more sensing signals are routed from the second RF communication component to the third RF communication component based at least in part on performing the first signal processing operation.

22. The method of claim 21, further comprising:
performing a second signal processing operation on the one or more reflections of the one or more sensing signals using an intermediate frequency module, a baseband component, or both, of the second RF communication component, wherein the second signal processing operation is performed based at least in part on performing the first signal processing operation, wherein the one or more reflections of the one or more sensing signals are routed from the second RF communication component to the third RF communication component based at least in part on performing the second signal processing operation.

23. The method of claim 21, further comprising:
performing an analog-to-digital conversion operation on the one or more reflections of the one or more sensing signals using an analog-to-digital component of the second RF communication component and based at least in part on performing the first signal processing operation, wherein the one or more reflections of the one or more sensing signals are routed from the second RF communication component to the third RF communication component based at least in part on performing the analog-to-digital conversion operation.

24. The method of claim 16, further comprising:
determining that the one or more RF communication components of the first set of one or more RF communication components are unavailable for the RF sensing procedure based at least in part on a location of the one or more objects, an orientation of the one or more RF communication components within the wireless communication device, or both.

25. The method of claim 16, further comprising:
determining that the one or more RF communication components of the first set of one or more RF communication components are unavailable for the RF sensing procedure based at least in part on a signal strength metric, a signal quality metric, or both, associated with signals received by the one or more RF communication components.

26. The method of claim 16, further comprising:
determining that the one or more RF communication components of the first set of one or more RF communication components are unavailable for the RF sensing procedure based at least in part on the one or more RF communication components being used for other wireless communication, another RF sensing procedure, a proximity sensing procedure, or any combination thereof.

27. The method of claim 16, further comprising:
determining that the one or more RF communication components of the first set of one or more RF communication components are unavailable for the RF sensing procedure based at least in part on a self-interference level associated with the one or more reflections of the one or more sensing signals received at the one or more RF communication components exceeding a threshold level.

28. The method of claim 16, wherein the RF sensing procedure is performed at a second time, the method further comprising:
transmitting additional sensing signals using the first RF communication component at a first time prior to the second time;
receiving reflections of the additional sensing signals at each of the second set of one or more RF communication components including the second RF communication component; and
generating a data object comprising RF sensing parameters between the first RF communication component and the second set of one or more RF communication components, wherein the second RF communication component is selected from the second set of one or more RF communication components based at least in part on referencing the data object.

29. A wireless communication device, comprising:
means for transmitting one or more sensing signals, associated with a radio frequency (RF) sensing procedure, using a first RF communication component from a first set of one or more RF communication components that are each associated with transmitting and receiving RF signals;
means for selecting, in association with one or more of the first set of one or more RF communication components being unavailable for the RF sensing procedure, a second RF communication component from a second set of one or more RF communication components that are each associated with receiving RF signals and not associated with transmitting RF signals; and
means for receiving one or more reflections of the one or more sensing signals using the second RF communication component.

30. A non-transitory computer-readable medium storing code, the code comprising instructions executable by one or more processors to:
transmit one or more sensing signals, associated with a radio frequency (RF) sensing procedure, using a first RF communication component from a first set of one or more RF communication components that are each associated with transmitting and receiving RF signals;
select, in association with one or more of the first set of one or more RF communication components being unavailable for the RF sensing procedure, a second RF communication component from a second set of one or more RF communication components that are each associated with receiving RF signals and not associated with transmitting RF signals; and
receive one or more reflections of the one or more sensing signals using the second RF communication component.
